(19) United States
(12) Patent Application Publication
(10) Pub. No.: US 2025/0151097 A1
(43) Pub. Date: May 8, 2025

(54) CAPABILITY-BASED BANDWIDTH RESTRICTIONS FOR WIRELESS COMMUNICATIONS

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US); Jing SUN, San Diego, CA (US); Jing JIANG, San Diego, CA (US)

(21) Appl. No.: 18/503,111

(22) Filed: Nov. 6, 2023

(51) Int. Cl. H04W 72/51; H04W 72/0453; H04W 72/23

(52) U.S. Cl. CPC H04W 72/51; H04W 72/0453; H04W 72/23

(57) ABSTRACT

Methods, systems, and devices for wireless communications are described. A user equipment (UE) may receive encoded data from a network entity. The UE may decode the data in accordance with a size of the circular buffer. The UE, the network entity, or both may determine the size of the circular buffer based on a capability of the UE. In some examples, the size of the circular buffer may be associated with one or more limits for performing the decoding operation, including a limit for a quantity of encoded bits the UE can process during a sliding window. For example, the limits may consider any combination of a quantity of encoded bits or information bits that the UE may write to or write from a memory of the UE. In some cases, the limits may consider multiple bandwidth parts, multiple component carriers, or any combination thereof.

### FIELD OF TECHNOLOGY

The following relates to wireless communications, including capability-based bandwidth restrictions for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support capability-based bandwidth restrictions for wireless communications. For example, the described techniques provide for a user equipment (UE) receiving encoded data from a network entity. The UE may decode the data in accordance with a size of the circular buffer that the UE, the network entity, or both may determine based on a capability of the UE. The size of the circular buffer may be associated with one or more limits for performing the decoding operation. In some cases, the circular buffer may be a circular buffer for a code block. In some such cases, size of the circular buffer may be referred to as Neb.

The one or more limits for performing the decoding operation and associated with the size of the circular buffer may include a limit for a quantity of encoded bits the UE can process during a time unit (e.g., a sliding window) for the decoding operation. In some examples, the limits may consider a quantity of encoded bits that the UE may write to or may write from the memory of the UE. Additionally, or alternatively, the limit for the quantity of encoded bits may consider undecoded code blocks (CBs) or may consider both decoded and undecoded CBs to be written to or read from the memory. In some cases, the limits may consider multiple bandwidth parts (BWPs), multiple component carriers (CCs), or any combination thereof over which the encoded bits are received. The UE may decode signaling received from the network entity in accordance with the size of the circular buffer.

### BRIEF DESCRIPTION OF THE DRAWINGS

FIG. 1 shows an example of a wireless communications system that supports capability-based bandwidth restrictions for wireless communications in accordance with one or more aspects of the present disclosure.

FIG. 2 shows an example of a wireless communications system that supports capability-based bandwidth restrictions for wireless communications in accordance with one or more aspects of the present disclosure.

FIG. 3 shows an example of a memory usage diagram that supports capability-based bandwidth restrictions for wireless communications in accordance with one or more aspects of the present disclosure.

FIG. 4 shows an example of a process flow that supports capability-based bandwidth restrictions for wireless communications in accordance with one or more aspects of the present disclosure.

FIGS. 5 and 6 show block diagrams of devices that support capability-based bandwidth restrictions for wireless communications in accordance with one or more aspects of the present disclosure.

FIG. 7 shows a block diagram of a communications manager that supports capability-based bandwidth restrictions for wireless communications in accordance with one or more aspects of the present disclosure.

FIG. 8 shows a diagram of a system including a device that supports capability-based bandwidth restrictions for wireless communications in accordance with one or more aspects of the present disclosure.

FIGS. 9 and 10 show block diagrams of devices that support capability-based bandwidth restrictions for wireless communications in accordance with one or more aspects of the present disclosure.

FIG. 11 shows a block diagram of a communications manager that supports capability-based bandwidth restrictions for wireless communications in accordance with one or more aspects of the present disclosure.

FIG. 12 shows a diagram of a system including a device that supports capability-based bandwidth restrictions for wireless communications in accordance with one or more aspects of the present disclosure.

FIGS. 13 through 16 show flowcharts illustrating methods that support capability-based bandwidth restrictions for wireless communications in accordance with one or more aspects of the present disclosure.

### DETAILED DESCRIPTION

In some wireless communications systems, a UE may communicate encoded data with a network entity. In some examples, the UE may perform a decoding operation to receive the data transmitted by the network entity. The UE may implement an incremental redundancy hybrid automatic repeat request (IR-HARQ) procedure to mitigate decoding errors during the decoding operations. For example, the UE may store (e.g., write) log-likelihood ratios (LLRs) associated with the IR-HARQ process (which may be an example of a retransmission process) to a memory (e.g., a low-power double data rate (LPDDR) synchronous dynamic random-access memory (SRAM)) of the UE. Additionally, as a part of the decoding operation, the UE may write bits to (e.g., offload), write bits from (e.g., onload) or both onload and offload bits (e.g., information bits, coded bits) to the memory of the UE. However, a bandwidth of the memory may limit an ability of the UE to write data to or from the memory, which may influence power consumption at the UE.

Additionally, as a part of the IR-HARQ procedure, the network entity may retransmit the encoded signaling to the UE if the UE fails to decode the initial encoded signaling. The UE may receive the encoded signaling during a time unit (e.g., a sliding window) and may store information related to the initial transmission and retransmissions in a buffer (e.g., a circular buffer). The size of the circular buffer may be based on a mother code length, a transport block size (TBS), a quantity of code blocks (CBs), or any combination thereof, where the TBS may be based on a configured quantity of layers, a modulation order, or a quantity of resource blocks (RBs). In some cases where the UE is configured with a low quantity of layers, a small modulation order, a low quantity of RBs, or any combination thereof, the TBS (and by extension, the size of the circular buffer) may be artificially limited. Additionally, or alternatively, the UE may receive a limited quantity of encoded bits during the time window due to a limitation associated with the sliding window.

Various aspects of the present disclosure relate to capability-based bandwidth restrictions for dynamic data rate memory access. A UE may transmit, to a network entity, an indication of a capability of the UE. In some examples, based on the capability, the UE or the network entity may determine a size for a circular buffer for performing a decoding operation on signals received from the network entity. The size of the circular buffer may be associated with one or more limits associated with performing the decoding operation. For example, the one or more limits may include a limit for a quantity of encoded bits (which may alternative be referred to as coded bits) the UE can process during the decoding operation. In some cases, the limit for the quantity of encoded bits may consider all component carriers (CCs) associated with a time unit (e.g., a sliding window) in which the code bits are received. In some other cases, the limit for the quantity of code bits may consider a quantity of code bits that the UE may write to a memory of the UE and a quantity of code bits that the UE may write from the memory of the UE. Additionally, or alternatively, the limit for the quantity of code bits may consider undecoded CBs (e.g., CBs that have been received in encoded form, which may alternatively be referred to as being in coded form, and have not yet been decoded by the UE) or may consider both decoded and undecoded CBs. The UE may decode signaling received form the network entity in accordance with the size of the circular buffer and the quantity of encoded bits, which the UE may determine based on the configuration information.

The UE and the network entity may implement IR-HARQ to improve robustness of communications (e.g., against inaccurate rate control, against burst-like interference), improve a coverage area associated with communications between the UE and the network entity, improve spectral efficiency of communications between the UE and the network entity, or any combination thereof.

Aspects of the disclosure are initially described in the context of wireless communications systems. Aspects of the disclosure are additionally described with reference to memory usage diagrams and process flows. Aspects of the disclosure are further illustrated by and described with reference to apparatus diagrams, system diagrams, and flowcharts that relate to capability-based bandwidth restrictions for wireless communications.

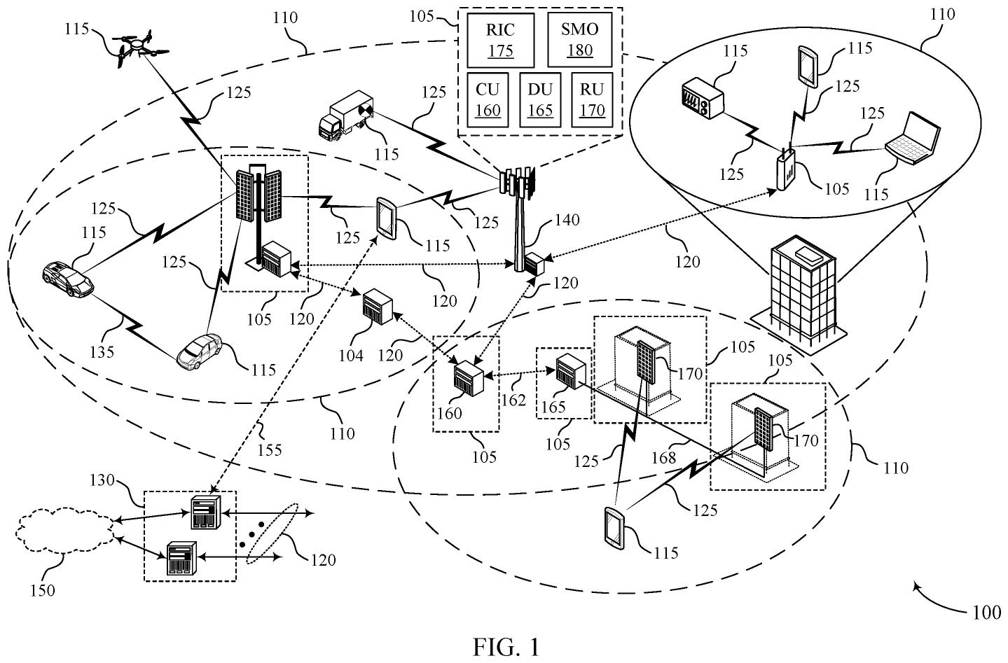

FIG. 1 shows an example of a wireless communications system 100 that supports capability-based bandwidth restrictions for wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support capability-based bandwidth restrictions for wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may receive encoded data from a network entity 105. In such examples, the UE 115 may transmit, to the network entity 105, an indication of a capability of the UE 115. The UE 115, the network entity 105, or both may determine a size for a circular buffer for performing a decoding operation. The decoding operation may be any type of operation related to processing (e.g., handling, decoding) one or more messages received by the UE 115 and may involve sending information to or receiving information from memory at the UE 115 that is used to implement the circular buffer. The size of the circular buffer may be associated with one or more limits for performing the decoding operation. For example, the one or more limits may include a limit for a quantity of encoded bits the UE 115 can process during a time unit (e.g., a sliding window) for the decoding operation. In some examples, the limits may consider a quantity of encoded bits that the UE 115 may write to a memory of the UE 115 and a quantity of encoded bits that the UE 115 may write from the memory of the UE 115. Additionally, or alternatively, the limit for the quantity of encoded bits may consider undecoded CBs or may consider both decoded and undecoded CBs. In some cases, the limits may consider multiple BWPs, multiple CCs, or any combination thereof over which the encoded bits are received. The UE 115 may decode signaling received from the network entity 105 in accordance with the size of the circular buffer and the quantity of encoded bits.

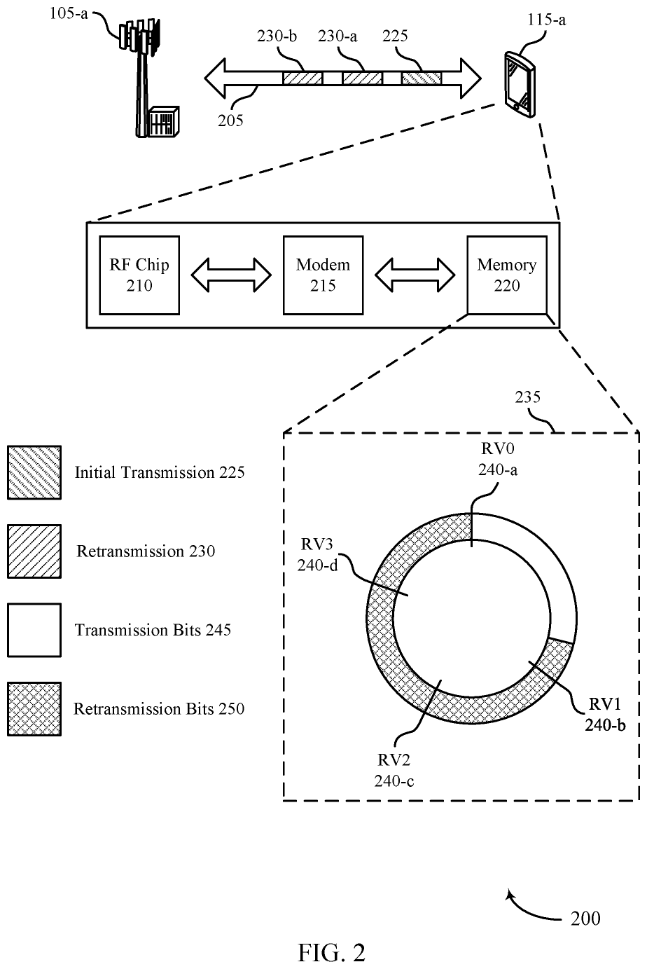

FIG. 2 shows an example of a wireless communications system 200 that supports capability-based bandwidth restrictions for wireless communications in accordance with one or more aspects of the present disclosure. The wireless communications system 200 may include a UE 115-a and a network entity 105-a, which may be examples of corresponding devices as described herein, including with reference to FIG. 1. The UE 115-a and the network entity 105-a may communicate over communications link 205, which may be a cellular (e.g., New Radio (NR)) communications link. Additionally, or alternatively, the UE 115-a and the network entity 105-a may communicate with each other over BWPs, over multiple CCs, or any combination thereof. In some examples, the UE 115-a may be comprised of a radio-frequency (RF) chip 210, a modem 215, and a memory 220. The memory 220 may be a random-access memory (RAM), such as a dynamic random-access memory (DRAM), and in some cases may be low-power double data rate (LPDDR) memory.

In some implementations, communications between the UE 115-a and the network entity 105-a may include communication of one or more bits carrying data (e.g., information bits). For example, the UE 115-a may receive an initial transmission 225 carrying information bits from the network entity 105-a via one or more CBs of a transport block (TB). The one or more CBs including the one or more bits may be encoded, and the UE 115-a may decode the CBs (e.g., encoded bits) to receive signaling from the network entity 105-a. The UE 115-a may perform decoding according to a capability of the UE 115-a.

In some examples, the UE 115-a may fail to successfully decode information included in the initial transmission 225 from the network entity 105-a and may indicate such decoding failure to the network entity 105-a. For example, the UE 115-a may transmit a HARQ non-acknowledgement (NACK) message to the network entity 105-a to indicate a decoding failure at the UE 115-a. In such examples, the network entity 105-a may retransmit the information to the UE 115-a. For example, the network entity 105-a may include the information in a retransmission 230 (e.g., in a first retransmission 230-a) to the UE 115-a. The network entity 105 may continue to retransmit the information to the UE 115-a (e.g., via a second retransmission 230-b) until it receives an indication that the UE 115-a has successfully decoded the information sent from the network entity 105-a. For example, the UE 115-a may successfully decode the second retransmission 230-b and may transmit a HARQ acknowledgement (ACK) message to the network entity 105-a.

In some examples, the UE 115-a, the network entity 105-a, or both may support incremental redundancy hybrid automatic repeat request (IR-HARQ) procedures to improve system robustness, coverage, and spectral efficiency. For example, the UE 115-a, the network entity 105-a, or both may implement IR-HARQ procedures to reduce decoding errors, a total quantity of retransmissions 230, or both. As a part of an IR-HARQ procedure, the UE 115-a may store (e.g., offload) information related to the initial transmission 225 that the UE 115-a failed to successfully decode (e.g., a failed transmission) in the memory 220. The information may include one or more log-likelihood ratios (LLRs) for the initial transmission 225 which the UE 115-a may use in a soft combining procedure. As a part of the soft combining procedure, the UE 115-a may offload LLRs for each failed transmission, including failed retransmissions 230 (e.g., the first retransmission 230-a), to the memory 220.

During soft combining, to successfully decode a retransmission 230 (e.g., the second retransmission 230-b), the UE 115-a may pull (e.g., onload) LLRs associated with previous instances of the initial transmission 225 (e.g., the initial transmission 225, the first retransmission 230-a) from the memory 220. The UE 115-a may use the LLRs to detect errors in the second retransmission 230-b and successfully decode the second retransmission 230-b. The UE 15-a may perform onloading and offloading of bits in accordance with a double data rate (DDR) bandwidth of the memory 220. Additionally, or alternatively, the UE 115-a may perform other operations that may access the memory 220, including onloading information bits associated with uplink transmissions from the UE 115-a, offloading information bits that have been successfully decoded by the UE 115-a, or any combination thereof.

The UE 115-a may store data associated with the initial transmission 225 and retransmissions 230 in a circular buffer 235 of the memory 220. The circular buffer 235 may store information associated with each instance of the initial transmission 225 (e.g., the initial transmission 225, retransmissions 230) as a separate redundancy version (RV) 240. In some examples, each RV 240 (e.g., RV0 240-a, RV1 240-b, RV2 240-c, RV3 240-d) may represent a starting position for the UE 115-a to store the coded bits for a CB of a transmission (e.g., an initial transmission 225, a retransmission 230). For example, the UE 115-a may store transmission bits 245 associated with the initial transmission 225 in a region of the circular buffer 235 starting from RV0 240-a. Similarly, the UE 115-a may store retransmission bits 250 associated with retransmissions 230 (e.g., the first retransmission 230-a, the second retransmission 230-b) in respective regions of the circular buffer 235 starting from RV1 240-b, starting from RV2 240-c, or starting from RV3 240-d. As a part of a rate-matching operation (e.g., a limited-buffer rate-matching (LBRM) operation), the UE 115-a may read data from the circular buffer 235 corresponding to a RV 240. For example, the UE 115-a may read data associated with the RV0 240-a by reading bits starting from RV0 240-a. The circular buffer 235 may be associated with a size N_{cb}, where N_{cb} is the smaller of N and N_{ref}. N_{cb} may be represented by Equation 1.

$${N}_{cb} = min ( N , {N}_{ref} ) \qquad ( 1 )$$

N may represent a mother code length based on a base graph (BG) type used by the network entity 105-a. N may be equal to 3*k bits for a BG1 or 5*k bits for a BG2, where k may represent a quantity of information bits included in one CB. N_{ref} may be equal to the quotient of a limit L and a quantity of CBs of a TB C. The limit L may be determined by the UE 115-a, the network entity 105-a, or both. N_{ref} may be represented by Equation 2.

$${N}_{ref} = ⌊ \frac{L}{C} ⌋ \qquad ( 2 )$$

The size of the circular buffer N_{cb} may be determined based on a capability of the UE 115-a. In such cases, the size of the circular buffer N_{cb} may not be associated with a configured quantity of layers, a configured modulation order, a configured quantity of RBs across BWPs, or any combination thereof. In some examples, the UE 115-a may determine multiple values for L that are supported by the UE 115-a and may report the values to the network entity 105-a via capability signaling (e.g., capability information). In such examples, the network entity 105-a may select one L value and may configure the UE 115-a with the L value, and the UE 115-a may calculate N_{ref} based on the selected L.

In some other examples, based on receiving an indication of a capability of the UE 115-a, the network entity 105-a may configure (e.g., via radio resource control (RRC) signaling) the UE 115-a with one or more parameters that determine an L value, an indication of whether the UE 115-a should enforce the L value, or both. In such examples, the network entity 105-a may control whether LBRM should be used independent of a configured quantity of layers, a configured modulation order, a configured quantity of RBs across BWPs, or any combination thereof. In some cases where the UE 115-a and the network entity 105-a are configured to communicate over multiple BWPs (e.g., support BWP switching), each of the one or more parameters may be associated with a respective BWP. For example, the UE 115-a may be configured with different L values for different BWPs.

Additionally, in such cases, the network entity 105-a, the UE 115-a, or both may enforce one or more restrictions on communications (e.g., retransmissions 230) before, during, or after BWP switching. For example, when performing BWP switching, the network entity 105-a may determine not to schedule retransmissions 230 (e.g., of a TB) on a new BWP that is not the initial BWP used by the network entity 105-a and the UE 115-a for an initial transmission (e.g., an initial TB). In such examples, the UE 115-a may flush (e.g., empty, clear) the circular buffer 235 after switching to the new BWP. Additionally, or alternatively, the network entity 105-a may check a first L value associated with the initial BWP against a second L value associated with the new BWP. The network entity 105-a may schedule retransmissions 230 if the first L value and the second L value are the same. Additionally, or alternatively, the network entity 105-a may check (e.g., compare, evaluate) a first circular buffer size N_{cb} value associated with the initial BWP against a second circular buffer size N_{cb} value associated with the new BWP. The network entity 105-a may schedule retransmissions 230 if the first Nep value and the second N_{cb} value are the same.

In some examples, the UE 115-a, the network entity 105-a, or both may enforce additional restrictions on the size N_{cb} of the circular buffer 235. For example, the network entity 105-a may enforce a restriction to ensure that L is greater than or equal to the quotient of a maximum TBS TBS_{LBRM} for an active (e.g., current) BWP and a code rate R_{ref} (e.g., a maximum code rate, an LBRM code rate) that is fixed or configured to the UE 115-a. Additionally, or alternatively, the UE 115-a may place additional considerations on the L value when calculating the size Neb of the circular buffer 235. For example, the UE 115-a may consider using the larger of the quotient of the maximum TBS TBS_{LBRM} for the active BWP and the code rate R_{ref} and the indicated L value when calculating the size Neb of the circular buffer 235. In such cases, the UE 115-a may calculate N_{ref} according to Equation 3.

$${N}_{ref} = ⌊ \frac{max ( \frac{{TBS}_{ref}}{{R}_{ref}} , L )}{C} ⌋ \qquad ( 3 )$$

Additionally, or alternatively, the UE 115-a may calculate Neb to be greater than the quotient of a quantity of information bits in a given CB K, and a code rate (e.g., a maximum code rate, an LBRM code rate). In such cases, the UE 115-a may calculate the size N_{cb} of the circular buffer 235 according to Equation 4.

$${N}_{ref} = min ( N , max ( {N}_{ref} , \frac{{K}_{r}}{{R}_{ref}} ) ) \qquad ( 4 )$$

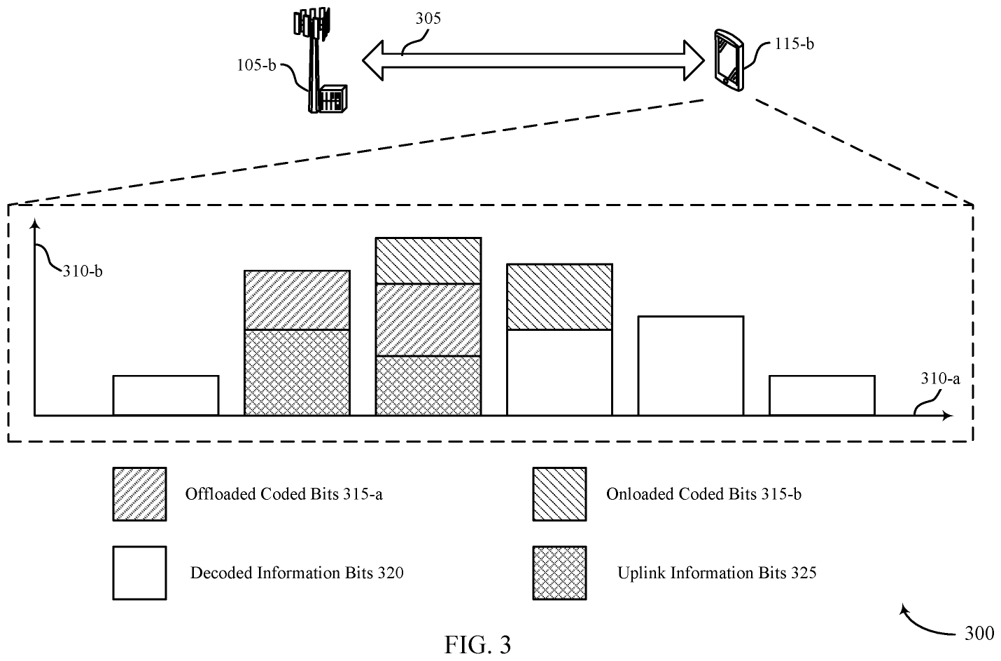

Additionally, the UE 115-a may operate in accordance with a sliding window. The sliding window may define a duration of symbols (e.g., 14 consecutive OFDM symbols) during which the UE 115-a can receive information (e.g., encoded bits) from the network entity 105-a. In some implementations, the UE 115-a, the network entity 105-a, or both may enforce a limit on a quantity of bits that the UE 115-a can process during a time unit (e.g., a sliding window), as described in further detail with respect to FIG. 3.

FIG. 3 shows an example of a memory usage diagram 300 that supports capability-based bandwidth restrictions for wireless communications in accordance with one or more aspects of the present disclosure. The memory usage diagram 300 may illustrate an example for implementing one or more aspects of the wireless communications system 100 or the wireless communications system 200. For example, the memory usage diagram 300 may depict or represent bits stored in a memory of a UE 115-b, which may be an example of a UE 115 as described with respect to FIG. 1 or a UE 115-a as described with respect to FIG. 2. The UE 115-b may receive the bits from a network entity 105-b, which may be an example of a network entity 105 as described with respect to FIG. 1 or a network entity 105-a as described with respect to FIG. 2. The UE 115-b and the network entity 105-b may communicate over communications link 305, which may be a cellular (e.g., New Radio (NR)) communications link. Additionally, or alternatively, the UE 115-b and the network entity 105-b may communicate with each other over multiple (BWPs), over multiple (CCs), or any combination thereof. In some examples, the horizontal axis 310-a of the memory usage diagram 300 may represent a time component of memory operations performed by the UE, and the vertical axis 310-b of the memory usage diagram 300 may represent a quantity of bits in use at the memory of the UE 115-b.

In some implementations, the bits transmitted by the network entity 105-b may be encoded, and the UE 115-b may perform a decoding operation to decode the bits and receive transmissions from the network entity 105-b. The UE 115-b may access the memory to perform offloading operations and onloading operations as a part of the decoding operation. In some cases, the UE 115-b may access the memory to manage encoded bits. For example, the UE 115-b may offload bits comprising LLRs associated with a transmission that the UE 115-b failed to decode in the memory (e.g., offloaded coded bits 315-a). Similarly, the UE 115-b may onload bits comprising LLRs for retransmissions associated with a failed transmission for performing soft combining on a current retransmission associated with the failed transmission (e.g., onloaded coded bits 315-b). In some other cases, the UE 115-b may access the memory to manage non-encoded bits (e.g., information bits). For example, the UE 115-b may offload decoded information bits 320 (e.g., successfully decoded bits) to the memory. Additionally, or alternatively, the UE 115-b may onload information bits associated with a scheduled (e.g., upcoming) uplink transmission at the UE 115-b (e.g., uplink information bits 325). The UE 115-b may perform the offloading and onloading operations on the memory simultaneously, at different times, or both.

The UE 115-b may receive the bits from the network entity 105-b in accordance with a sliding window and a sliding window limit. The sliding window may define a duration of symbols (e.g., 14 consecutive OFDM symbols) during which the UE 115-b can receive the bits from the network entity 105-b. In some examples, the UE 115-b, the network entity 105-b, or both may enforce a limit on a quantity of bits that the UE 115-b can process during a given sliding window (e.g., the sliding window limit). The sliding window limit may be based on a capability of the UE 115-b.

For example, in some cases where the UE 115-b communicates with the network entity 105-b across multiple CCs, the UE 115-b may consider multiple CCs when calculate the sliding window limit. In some examples, the multiple CCs may include all CCs associated with the UE 115-b, all CCs within a cell group (e.g., a master cell group (MCG), a secondary cell group (SCG)), or all CCs within a frequency range (e.g., a first frequency range, a second frequency range). Additionally, or alternatively, the multiple CCs may include configured CCs (e.g., configured by RRC), activated CCs (e.g., activated secondary cells (SCells) in addition to activated primary cells (PCells), non-dormant CCs), or both.

In such examples, the UE 115-b may calculate the sliding window limit based on CC indices ϰ, one or more TB indices i of the total TBs Sₖ, a quantity of scheduled CBs Cᵢ′, a quantity of OFDM symbols assigned to a physical downlink shared channel (PDSCH) carrying the bits Lᵢ, a quantity of OFDM symbols received during a consecutive symbol duration (e.g., the sliding window) xᵢ, a quantity of coded bits in one CB of a TB associated with a current transmission or a current retransmission received by the UE 115-b Fᵢ, a limit L, and a time unit. Fᵢ may be calculated based on a quantity of bits in a circular buffer k_{0,i}^{j}+Eᵢ^{j} associated with a current transmission or a current retransmission of an ith TB and a calculated circular buffer size N_{cb,i}. Fᵢ may be defined by Equation 5.

$${F}_{i} = {max}_{j = 0 , … , J - 1} ( min ( {k}_{0 , i}^{j - 1} + {E}_{i}^{j - 1} , {N}_{cb , i} ) ) \qquad ( 5 )$$

The time unit may be a sliding window (e.g., 14 consecutive ODFM symbols), and the sliding window bay be based on a smallest subcarrier spacing (SCS) configured to the UE 115-b across the active BWPs of the multiple CCs. The limit L may be based on a capability of the UE 115-b as described with respect to FIG. 2. The sliding window limit may be represented by Equation 6.

$${\sum }_{k ∈ κ} {\sum }_{i ∈ {S}_{k}} ⌊ \frac{{C}_{i}^{′}}{{L}_{i}} ⌋ {x}_{i} * {F}_{i} \leq L \qquad ( 6 )$$

In some cases where the limit L is not satisfied (e.g., is less than a threshold value), the UE 115-b may drop one or more TBs, CBs, or CB groups (CBGs) according to a configuration (e.g., a preconfiguration) at the UE 115-b. Additionally, or alternatively, the UE 115-b may determine that communications associated with the limit L are erroneous (e.g., may declare an error state).

In some other examples, the UE 115-b may calculate multiple sliding window limits associated with offloading operations and onloading operations at the UE 115-b. In such other examples, the UE 115-b may consider all CCs of the UE 115-b when calculating the multiple sliding window limits. For example, the UE 115-b may calculate a first limit associated with offloading bits (e.g., offloaded coded bits 315-a) during the sliding window based on one or more TB indices i of the total TBs S, a quantity of undecoded scheduled CBS C_{i,undecoded}′, the quantity of OFDM symbols assigned to a PDSCH carrying the bits Lᵢ, the quantity of OFDM symbols received during a consecutive symbol duration (e.g., the sliding window) xᵢ, a quantity of coded bits in one CB of a TB associated with a current transmission or a current retransmission received by the UE 115-b Fᵢ″, and the limit L. The first limit (e.g., the offloading limit) may be defined by Equation 7.

$${\sum }_{i ∈ S} ⌊ \frac{{C}_{i , undecoded}^{′}}{{L}_{i}} ⌋ {x}_{i} * {F}_{i}^{″} \leq L \qquad ( 7 )$$

In some cases, the UE 115-b may calculate Fᵢ″ based on offloading all LLRs associated with an uncoded CB, including LLRs that are common or unchanged between transmission instances (e.g., retransmissions). In such cases, Fᵢ″ may be equal to Fᵢ as defined in Equation 5. In some other cases, the UE 115-b may calculate Fᵢ″ based on offloading LLRs associated with a current retransmission that are different from LLRs associated with previous retransmissions. That is, the UE 115-b may not offload LLRs that are unchanged compared to previous retransmissions, as the unchanged LLRs may already be represented (e.g., maintained) in the memory by bits associated with the previous retransmissions. In such other cases, Fᵢ″ may be calculated based on a quantity of bits in a circular buffer k_{0,i}^{J-1}+Eᵢ^{J-1} associated with a J−1th transmission (e.g., a current retransmission) of an ith TB and a calculated circular buffer size N_{cb,i}. Fᵢ″ may be defined by Equation 8.

$${F}_{i}^{″} = min ( {k}_{0 , i}^{J - 1} + {E}_{i}^{J - 1} , {N}_{cb , i} ) \qquad ( 8 )$$

Similarly, in such other examples, the UE 115-b may calculate a second limit associated with onloading bits (e.g., onloaded coded bits 315-b) during the sliding window based on the one or more TB indices i of the total TBs S, a quantity of previously received CBs Cᵢ′ (which may be a quantity of previously received undecoded CBs C_{i,undecoded}′), the quantity of OFDM symbols assigned to a PDSCH carrying the bits Lᵢ, the quantity of OFDM symbols received during the sliding window xᵢ, a quantity of coded bits in one CB of a TB associated with previous transmissions received by the UE 115-b Fᵢ′, and the limit L. The second limit (e.g., the onloading limit) may be defined by Equation 9.

$${\sum }_{i ∈ S} ⌊ \frac{{C}_{i}^{′}}{{L}_{i}} ⌋ {x}_{i} * {F}_{i}^{′} \leq L \qquad ( 9 )$$

In some cases, the UE 115-b may calculate Fᵢ′ based on loading LLRs of previous transmissions or retransmissions that are associated with a current uncoded CB. In such other cases, the UE 115-b may calculate F/based on a quantity of bits in a circular buffer k_{0,i}^{J}+Eᵢ^{J} associated with a jth transmission with index j=0, 1, . . . , J−2 of an ith TB (e.g., considering all previous retransmissions except for the current retransmission) and a calculated circular buffer size N_{cb,i}. In some examples where J=1 (e.g., for a current transmission that is also an initial transmission), F/may be equal to zero. Fᵢ′ may be defined by Equation 10.

$${F}_{i}^{′} = \{ \begin{matrix}0 , & J = 1 \\ {max}_{j = 0 , … , J - 2} ( min ( {k}_{0 , i}^{j - 1} + {E}_{i}^{j - 1} , {N}_{cb , i} ) ) & J > 1\end{matrix} \qquad ( 10 )$$

When managing (e.g., offloading, onloading) LLRs, the UE 115-b may additionally consider an LLR bitwidth (e.g., a bitwidth of an LLR may refer to a quantity of bits used to represent the LLR). For example, the UE 115-b may calculate the limit L based on the LLR bitwidth, and may indicate the LLR bitwidth (e.g., implicitly) when indicating the limit L. Alternatively, the UE 115-b may indicate the LLR bitwidth separately from the limit L (e.g., via an explicit indication). In some examples, the UE 115-b may calculate and report, to the network entity, separate values for the first limit (e.g., the offloading limit) and the second limit (e.g., the onloading limit). In some other examples, the UE 115-b may indicate the multiple sliding window limits as one joint limit. The joint limit may define a first quantity of bits for offloading and a second (e.g., different) quantity of bits for onloading as described herein. Accordingly, the joint limit may be defined by Equation 11.

$${\sum }_{i ∈ S} ⌊ \frac{{C}_{i , undecoded}^{′}}{{L}_{i}} ⌋ {x}_{i} * {F}_{i}^{″} + {\sum }_{i ∈ S} ⌊ \frac{{C}_{i}^{′}}{{L}_{i}} ⌋ {x}_{i} * {F}_{i}^{′} \leq L \qquad ( 11 )$$

Additionally, or alternatively, in some examples the UE 115-b may calculate a joint limit that considers any combination of offloading procedures and onloading procedures for both coded bits and information bits. In such examples, the UE 115-b may calculate the joint limit according to one or more aspects of the present disclosure as described herein. For example, the joint limit may be defined across multiple CCs or may be defined per-CC. Additionally, the UE 115-b may calculate a limit for offloading bits (e.g., offloaded coded bits 315-a) in accordance with Equation 6, a limit for onloading bits (e.g., onloaded coded bits 315-b) in accordance with Equation 8. Similarly, the UE 115-b may calculate limits for any combination of offloading and onloading information bits. The UE 115-b may calculate a limit for offloading information bits (e.g., decoded information bits 320) based on the one or more TB indices i of the total TBs S, the quantity of scheduled CBs Cᵢ′, the quantity of OFDM symbols assigned to a PDSCH carrying the bits Lᵢ, the quantity of OFDM symbols received during the sliding window xᵢ, and a quantity of information bits in one CB of the ith TB associated with a successfully decoded transmission at the UE 115-b K_{r,i}. The limit for offloading information bits may be defined by Equation 12.

$${\sum }_{i ∈ S} ⌊ \frac{{C}_{i , decoded}^{′}}{{L}_{i}} ⌋ {x}_{i} * {K}_{r , i} \qquad ( 12 )$$

Similarly, the UE 115-b may calculate a limit for onloading information bits (e.g., uplink information bits 325) based on one or more TB indices i of total uplink TBs S_{UL} (e.g., associated with a physical uplink shared channel (PUSCH)), the quantity of scheduled CBs Cᵢ′, the quantity of OFDM symbols assigned to a PDSCH carrying the bits Lᵢ, the quantity of OFDM symbols received during the sliding window xᵢ, and the quantity of information bits in one CB of the ith uplink TB associated with a successfully decoded transmission at the UE 115-b K_{r,i}. The limit for onloading information bits may be defined by Equation 13.

$${\sum }_{i ∈ {S}_{UL}} ⌊ \frac{{C}_{i}^{′}}{{L}_{i}} ⌋ {x}_{i} * {K}_{r , i} \qquad ( 13 )$$

In such examples, the UE 115-b may calculate the joint limit in accordance with some or all of the calculated sliding window limits. For example, in some cases the joint limit may include all calculated sliding window limits, including the limit for the offloaded coded bits 315-a (as defined in Equation 6), the limit for the onloaded coded bits 315-b (as defined in Equation 8), the limit for offloading the decoded information bits 320 (as defined in Equation 11), and the limit for onloading the uplink information bits 325 (as defined in Equation 12). The joint limit may be defined by the sum of the calculated sliding window limits, and the UE 115-b may enforce a restriction on the joint limit to be less than the limit L determined according to the capability of the UE 115-b. In some implementations, the sum of the calculated sliding window bits may be a weighted sum, where some of the sliding window limits that comprise the joint limit may be weighted higher than the other sliding window limits. For example, when calculating the joint limit, the UE 115-b may impose a larger limit (e.g., more available bits) on the offloaded coded bits 315-a and the onloaded coded bits 315-b than on the decoded information bits 320 or the uplink information bits 325. In such implementations, the UE 115-b may implement the weighted limit to account for the LLR quantization (e.g., a bitwidth for each LLR) associated with the offloaded coded bits 315-a and the onloaded coded bits 315-b.

Alternatively, in some cases, a timeline for uplink transmissions at the UE 115-b may not align (e.g., in time) with a timeline for downlink transmissions at the UE 115-b. Accordingly, the joint limit may include the limit for the offloaded coded bits 315-a (as defined in Equation 6), the limit for the onloaded coded bits 315-b (as defined in Equation 8), the limit for offloading the decoded information bits 320 (as defined in Equation 11). In such cases, the joint limit may not include the limit for onloading the uplink information bits 325 (as defined in Equation 12) that may not align with the other calculated sliding window limits (e.g., associated with downlink transmissions). The UE 115-b may enforce a restriction on the joint limit to be less than the limit L determined according to the capability of the UE 115-b. In some implementations, the joint limit may be based on a weighted sum, where some of the sliding window limits that comprise the joint limit (e.g., limits associated with encoded bits) may be weighted higher than the other sliding window limits (e.g., limits associated with information bits. In such implementations, the UE 115-b may implement the weighted limit to account for the LLR quantization (e.g., a bitwidth for each LLR) associated with the offloaded coded bits 315-a and the onloaded coded bits 315-b.

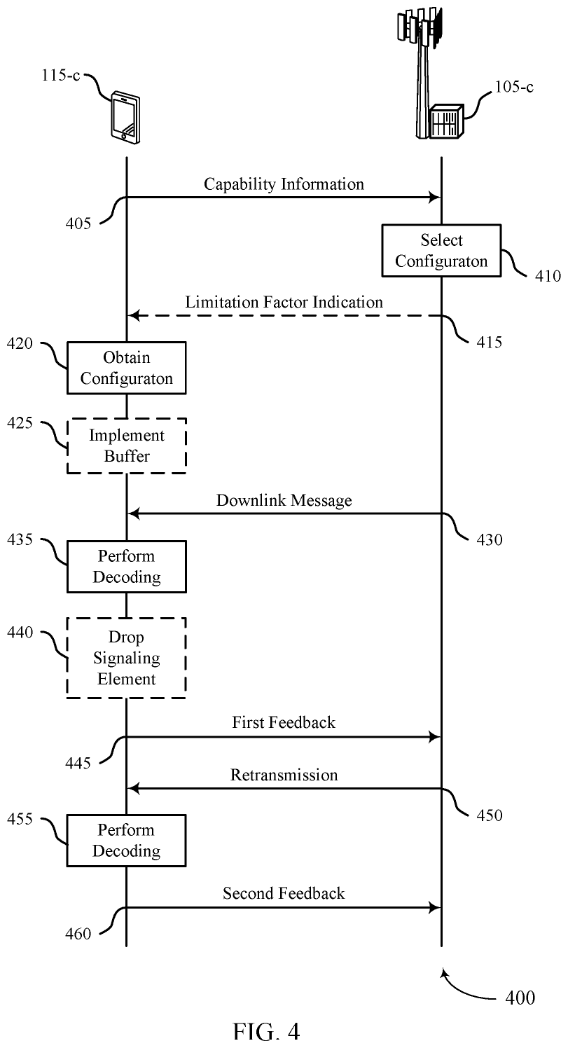

FIG. 4 shows an example of a process flow 400 that supports capability-based bandwidth restrictions for wireless communications in accordance with one or more aspects of the present disclosure. The process flow 400 may implement or be implemented by aspects of the wireless communications system 100, the wireless communications system 200, and the memory usage diagram 300 as described with reference to FIGS. 1, 2, and 3. For instance, in the example of FIG. 4, a UE 115-c may be in communication with network entity 105-c, which may be examples of devices described herein with reference to FIG. 1 or FIG. 2. In the following description of the process flow 400, the operations between the UE 115-c and the network entity 105-c may be performed in a different order than the example shown, or the operations between the UE 115-c and the network entity 105-c may be performed in different orders at different times. Some operations may also be omitted from the process flow 400, and other operations may be added to the process flow 400.

At 405, the UE 115-c may transmit capability information for the UE 115-c. In some examples, the UE 115-c may transmit the capability information to the network entity 105-c. The capability information may be associated with a size of a buffer at the UE 115-c that is associated with one or more retransmission processes (e.g., HARQ processes, each of which in some cases may be associated with a separate process ID such as a HARQ ID) at the UE 115-c, where the buffer is a circular buffer for a CB. The capability information for the UE 115-c may indicate a set of candidate limitation factors for the size of the buffer at the UE 115-c.

In some examples, the capability information for the UE 115-c may be based on one or more limits associated with accessing the memory at the UE. For example, the size of the buffer at the UE 115-c may be based on a limitation factor associated with the capability information for the UE 115-c. The limitation factor may have an allowable range with a lower bound that is based on a TBS limit and a code rate, where the TBS limit is based on a maximum quantity of transmission layers, a maximum modulation order, a maximum quantity of RBs, or any combination thereof for an active BWP for the UE 115-c.

In some other examples, the size of the buffer at the UE is based at least in part on a maximum value from among a set of values that comprises a first quantity and a second quantity, the first quantity comprising a limitation factor associated with the capability information for the UE, the second quantity based at least in part on a TBS limit and a code rate, and the TBS limit based at least in part on a maximum quantity of transmission layers, a maximum modulation order, a maximum quantity of RBs, or any combination thereof for an active BWP for the UE.

Additionally, or alternatively, the size of the buffer at the UE 115-c may be based on a maximum value from among a set of values that includes a first quantity and a second quantity. In such cases, the first quantity may be based on a limitation factor associated with the capability information for the UE, and the second quantity may be based on a quantity of information bits in a CB.

At 410, the network entity 105-c may select a configuration for the UE 115-c associated with one or more decoding operations for respective one or more downlink messages to the UE 115-c. The configuration may be based on the capability information for the UE 115-c.

In some examples, at 415, the UE 115-c may receive, from the network entity 105-c, an indication of a selected limitation factor (e.g., configuration) from among the set of candidate limitation factors. In some other examples, the UE 115-c may receive, from the network entity 105-c, control signaling that indicates whether the size of the buffer at the UE 115-c is subject to a limitation factor, one or more parameters that are associated with the limitation factor for the size of the buffer at the UE 115-c and are associated with one or more BWPs via which the UE 115-c is configured to communicate, or any combination thereof.

At 420, the UE 115-c may obtain the configuration associated with the decoding operations for the respective one or more downlink messages to the UE 115-c. In some examples, the configuration may be based on the capability information for the UE 115-c. As a part of obtaining the configuration, the UE 115-c may receive, from the network entity 105-c, the indication of the selected limitation factor or the control signaling that indicates whether the size of the buffer at the UE is subject to a limitation factor. In some implementations, the configuration may include a limit for a total quantity of coded bits that the UE 115-c is to decode within a time period across multiple CCs. In such implementations, the multiple CCs may include CCs of a cell group, CCs within a frequency range, or all CCs configured for transmissions to the UE 115-c.

Additionally, or alternatively, in some examples the configuration may include a limit associated with one or more TBs that the UE is to decode within a time period. In such cases, satisfaction of the limit may be based on a quantity of undecoded CBs for the time period. The satisfaction of the limit may be independent of one or more prior transmissions of a CB or a TB included in the one or more TB.

In some other examples, the configuration may include a limit associated with the one or more TBs that the UE is to decode within a time period. In such other cases, an initial transmission of a CB or a TB included in the one or more TBs may not count against the limit. Satisfaction of the limit may be independent of one or more current retransmissions for the one or more TBs.

In yet some other cases, the configuration may include a limit associated with the one or more TBs that the UE is to decode within a time period. In such cases, satisfaction of the limit may be based on a sum of a first quantity and a second quantity, where the first quantity may be based on a quantity of undecoded CBs for the time period, and the second quantity may be independent of the initial transmission or a current retransmission of a CB or a TB included in the one or more TBs. In some examples, satisfaction of the limit may be based on a sum of the first quantity, the second quantity, and a third quantity. The third quantity may be based on a quantity of decoded CBs for the time period. In some other examples, satisfaction of the limit may be based on a sum of the first quantity, the second quantity, a third quantity, and a fourth quantity, where the fourth quantity may be based on a quantity of bits for one or more uplink TBs scheduled for the time period.

At 425, the UE 115-c may implement the buffer using memory at the UE 115-c, where the buffer is a circular buffer for a CB.

At 430, the network entity 105-c may output (e.g., transmit) a downlink message to the UE 115-c. In some implementations, the downlink message may include one or more encoded bits associated with the one or more decoding operations at the UE 115-c.

At 435, the UE 115-c may perform a decoding operation (e.g., of the one or more decoding operations) for the downlink message in accordance with the configuration. For example, the UE 115-c may perform the decoding operation on the downlink message in accordance with the limitation factors indicated in the configuration.

At 440, the UE 115-c may drop a TB, a CB, a CBG, or any combination thereof based on a quantity of coded bits scheduled for the UE 115-c within the time period exceeding the limit (e.g., indicated by the configuration).

At 445, the UE 115-c may transmit feedback (e.g., first feedback) to the network entity 105-c based on the decoding operation for the downlink message. The UE 115-c may transmit the feedback in accordance with the one or more retransmission processes. For example, in some cases where the UE 115-c fails to decode the downlink message, the UE 115-c may transmit a NACK to the network entity 105-c.

At 450, the network entity 105-c may transmit a retransmission to the UE 115-c (e.g., retransmit the downlink message). In some cases where the UE 115-c switches BWPs during communications with the network entity 105-c, for an initial transmission in a first BWP included in the one or more BWPs, a retransmission in accordance with the one or more retransmission processes at the UE may be restricted to the first BWP. That is, the UE 115-c, the network entity 105-c, or both may restrict retransmissions of the initial transmission associated with the first BWP to the first BWP.

In some other cases where the UE 115-c switches BWPs during communications with the network entity 105-c, for an initial transmission in a first BWP included in the one or more BWPs and associated with the size of the buffer, a retransmission in accordance with the one or more retransmission processes at the UE 115-c may be restricted, based on the size of the buffer at the UE 115-c being subject to the limitation factor, from being in any BWP associated with a buffer size that is different than the size of the buffer.

At 455, the UE 115-c may perform a second decoding operation (e.g., of the one or more decoding operations) for the retransmission in accordance with the configuration. For example, the UE 115-c may perform the decoding operation on the retransmission in accordance with the limitation factors indicated in the configuration.

At 460, the UE 115-c may transmit feedback (e.g., second feedback) to the network entity 105-c based on the decoding operation for the retransmission. The UE 115-c may transmit the feedback in accordance with the one or more retransmission processes. For example, in some cases where the UE 115-c successfully decodes the downlink message, the UE 115-c may transmit an ACK to the network entity 105-c.

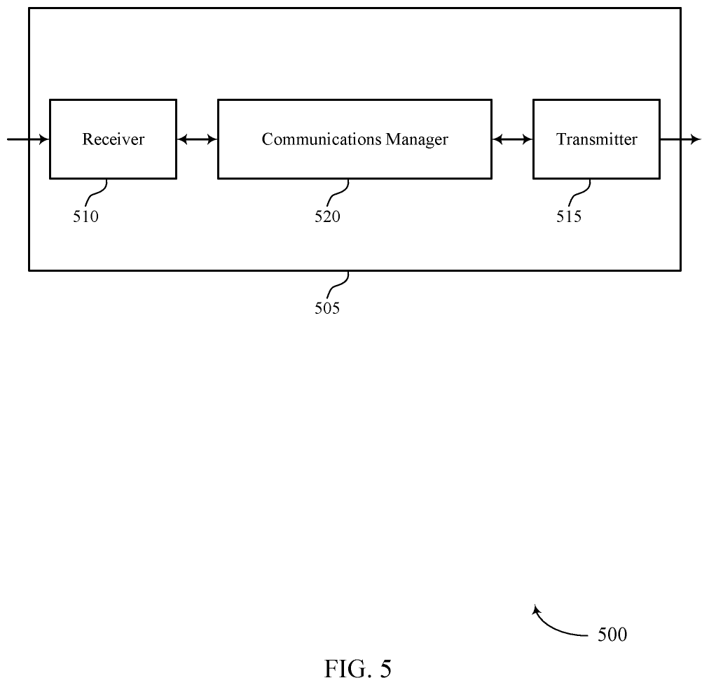

FIG. 5 shows a block diagram 500 of a device 505 that supports capability-based bandwidth restrictions for wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to capability-based bandwidth restrictions for wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to capability-based bandwidth restrictions for wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of capability-based bandwidth restrictions for wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting capability information for the UE, where the capability information is associated with a size of a buffer at the UE that is associated with one or more retransmission processes at the UE. The communications manager 520 is capable of, configured to, or operable to support a means for obtaining a configuration associated with decoding operations for one or more downlink messages to the UE, the configuration based on the capability information for the UE. The communications manager 520 is capable of, configured to, or operable to support a means for performing a decoding operation for a downlink message in accordance with the configuration. The communications manager 520 is capable of, configured to, or operable to support a means for transmitting feedback based on the decoding operation for the downlink message, the feedback in accordance with the one or more retransmission processes.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

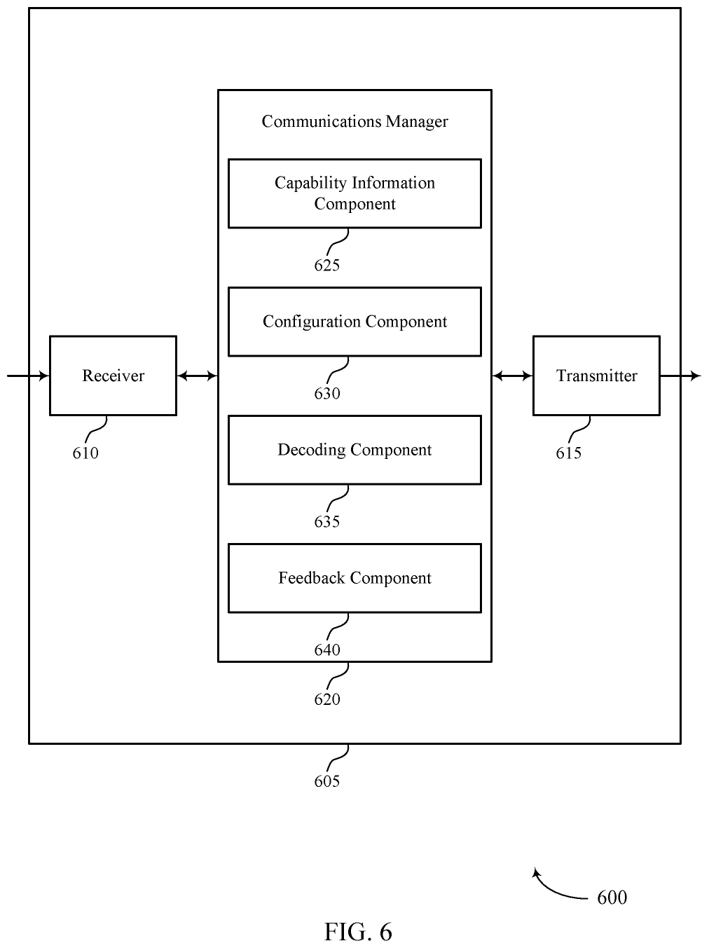

FIG. 6 shows a block diagram 600 of a device 605 that supports capability-based bandwidth restrictions for wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to capability-based bandwidth restrictions for wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to capability-based bandwidth restrictions for wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of capability-based bandwidth restrictions for wireless communications as described herein. For example, the communications manager 620 may include a capability information component 625, a configuration component 630, a decoding component 635, a feedback component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The capability information component 625 is capable of, configured to, or operable to support a means for transmitting capability information for the UE, where the capability information is associated with a size of a buffer at the UE that is associated with one or more retransmission processes at the UE. The configuration component 630 is capable of, configured to, or operable to support a means for obtaining a configuration associated with decoding operations for one or more downlink messages to the UE, the configuration based on the capability information for the UE. The decoding component 635 is capable of, configured to, or operable to support a means for performing a decoding operation for a downlink message in accordance with the configuration. The feedback component 640 is capable of, configured to, or operable to support a means for transmitting feedback based on the decoding operation for the downlink message, the feedback in accordance with the one or more retransmission processes.

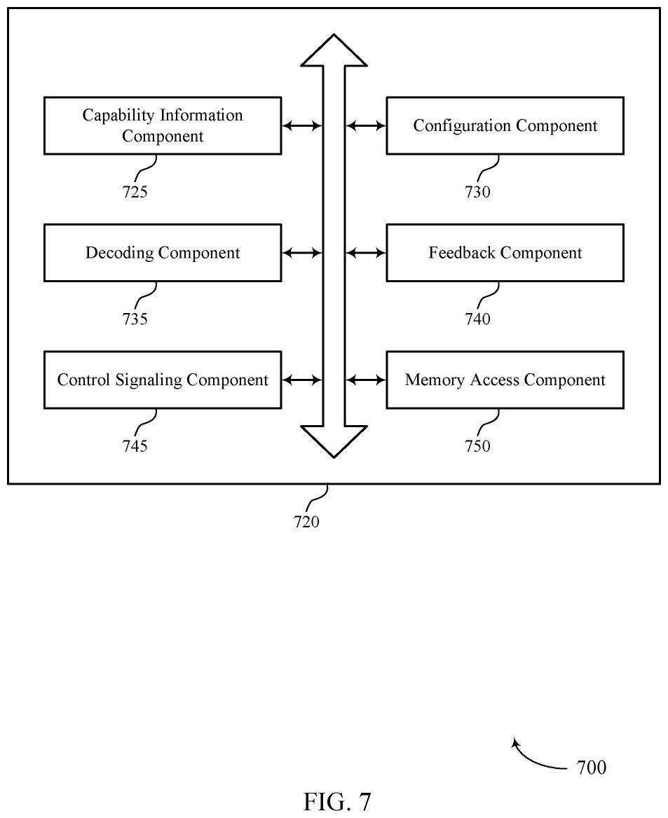

FIG. 7 shows a block diagram 700 of a communications manager 720 that supports capability-based bandwidth restrictions for wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of capability-based bandwidth restrictions for wireless communications as described herein. For example, the communications manager 720 may include a capability information component 725, a configuration component 730, a decoding component 735, a feedback component 740, a control signaling component 745, a memory access component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The capability information component 725 is capable of, configured to, or operable to support a means for transmitting capability information for the UE, where the capability information is associated with a size of a buffer at the UE that is associated with one or more retransmission processes at the UE. The configuration component 730 is capable of, configured to, or operable to support a means for obtaining a configuration associated with decoding operations for one or more downlink messages to the UE, the configuration based on the capability information for the UE. The decoding component 735 is capable of, configured to, or operable to support a means for performing a decoding operation for a downlink message in accordance with the configuration. The feedback component 740 is capable of, configured to, or operable to support a means for transmitting feedback based on the decoding operation for the downlink message, the feedback in accordance with the one or more retransmission processes.

In some examples, the capability information for the UE indicates a set of candidate limitation factors for the size of the buffer at the UE. In some examples, obtaining the configuration includes receiving, from a network entity, an indication of a selected limitation factor from among the set of candidate limitation factors.

In some examples, to support obtaining the configuration, the control signaling component 745 is capable of, configured to, or operable to support a means for receiving, from a network entity, control signaling that indicates whether the size of the buffer at the UE is subject to a limitation factor, one or more parameters that are associated with the limitation factor for the size of the buffer at the UE and are associated with one or more BWPs via which the UE is configured to communicate, or any combination thereof.

In some examples, for an initial transmission in a first BWP included in the one or more BWPs, a retransmission in accordance with the one or more retransmission processes at the UE is restricted to the first BWP.

In some examples, for an initial transmission in a first BWP included in the one or more BWPs and associated with the size of the buffer, a retransmission in accordance with the one or more retransmission processes at the UE is restricted, based on the size of the buffer at the UE being subject to the limitation factor, from being in any BWP associated with a buffer size that is different than the size of the buffer.

In some examples, the size of the buffer at the UE is based on a limitation factor associated with the capability information for the UE. In some examples, the limitation factor has an allowable range with a lower bound that is based on a TBS limit and a code rate, the TBS limit based on a maximum quantity of transmission layers, a maximum modulation order, a maximum quantity of RBs, or any combination thereof for an active BWP for the UE.

In some examples, the size of the buffer at the UE is based on a maximum value from among a set of values that includes a first quantity and a second quantity, the first quantity including a limitation factor associated with the capability information for the UE, the second quantity based on a TBS limit and a code rate, and the TBS limit based on a maximum quantity of transmission layers, a maximum modulation order, a maximum quantity of RBs, or any combination thereof for an active BWP for the UE.

In some examples, the size of the buffer at the UE is based on a maximum value from among a set of values that includes a first quantity and a second quantity, the first quantity based on a limitation factor associated with the capability information for the UE, the second quantity based on a quantity of information bits in a CB.

In some examples, the configuration includes a limit for a total quantity of coded bits that the UE is to decode within a time period across a set of multiple component carriers.

In some examples, the set of multiple component carriers includes component carriers of a cell group, component carriers within a frequency range, or all component carriers configured for transmissions to the UE.

In some examples, the configuration component 730 is capable of, configured to, or operable to support a means for dropping a TB, a CB, a CB group, or any combination thereof based on a quantity of coded bits scheduled for the UE within the time period exceeding the limit.

In some examples, the configuration includes a limit associated with one or more TBs that the UE is to decode within a time period, and where satisfaction of the limit is based on a quantity of undecoded CBs for the time period.

In some examples, satisfaction of the limit is independent of one or more prior transmissions of a CB or a TB included in the one or more TBs.

In some examples, the configuration includes a limit associated with one or more TBs that the UE is to decode within a time period, where an initial transmission of a CB or a TB included in the one or more TBs does not count against the limit, and where satisfaction of the limit is independent of one or more current retransmissions for the one or more TBs.

In some examples, the configuration includes a limit associated with one or more TBs that the UE is to decode within a time period, and where satisfaction of the limit is based on a sum of a first quantity and a second quantity, the first quantity based on a quantity of undecoded CBs for the time period, and the second quantity independent of an initial transmission or a current retransmission of a CB or a TB included in the one or more TBs.

In some examples, satisfaction of the limit is based on a sum of the first quantity, the second quantity, and a third quantity, and where the third quantity is based on a quantity of decoded CBs for the time period.

In some examples, satisfaction of the limit is based on a sum of the first quantity, the second quantity, a third quantity, and a fourth quantity, and where the fourth quantity is based on a quantity of bits for one or more uplink TBs scheduled for the time period.

In some examples, the memory access component 750 is capable of, configured to, or operable to support a means for implementing the buffer using memory at the UE, where the capability information for the UE is based on one or more limits associated with accessing the memory at the UE.

In some examples, the buffer is a circular buffer for a CB.

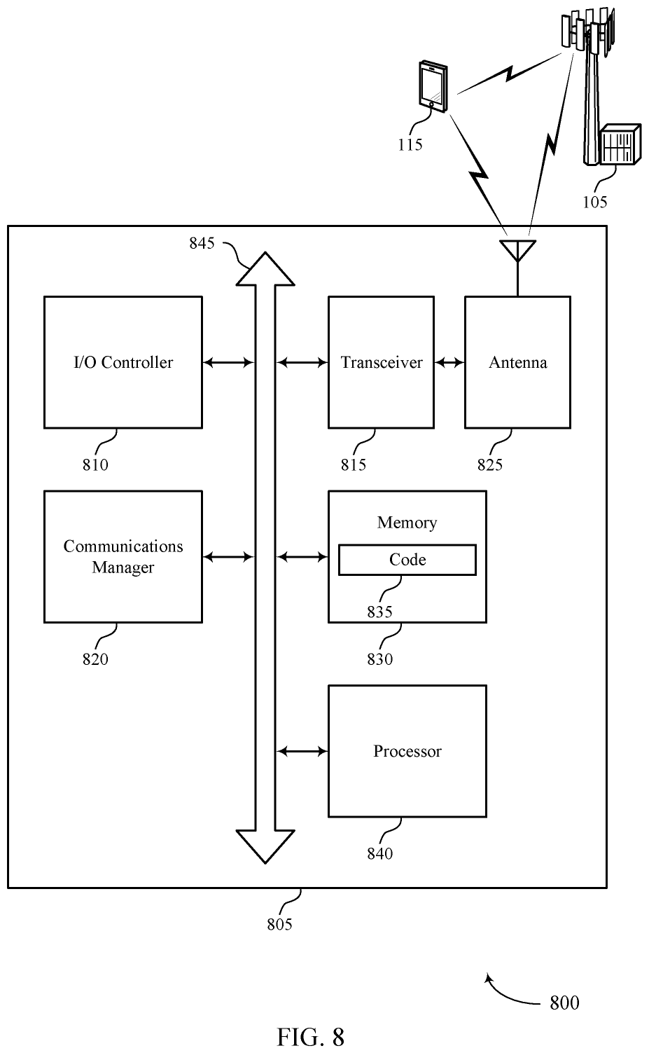

FIG. 8 shows a diagram of a system 800 including a device 805 that supports capability-based bandwidth restrictions for wireless communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting capability-based bandwidth restrictions for wireless communications). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting capability information for the UE, where the capability information is associated with a size of a buffer at the UE that is associated with one or more retransmission processes at the UE. The communications manager 820 is capable of, configured to, or operable to support a means for obtaining a configuration associated with decoding operations for one or more downlink messages to the UE, the configuration based on the capability information for the UE. The communications manager 820 is capable of, configured to, or operable to support a means for performing a decoding operation for a downlink message in accordance with the configuration. The communications manager 820 is capable of, configured to, or operable to support a means for transmitting feedback based on the decoding operation for the downlink message, the feedback in accordance with the one or more retransmission processes.

By including or configuring the communications manager 820 in accordance with examples as described herein, the device 805 may support techniques for reduced latency and improved user experience related to reduced power consumption and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of capability-based bandwidth restrictions for wireless communications as described herein, or the at least one processor 840 and the at least one memory 830 may be otherwise configured to, individually or collectively, perform or support such operations.

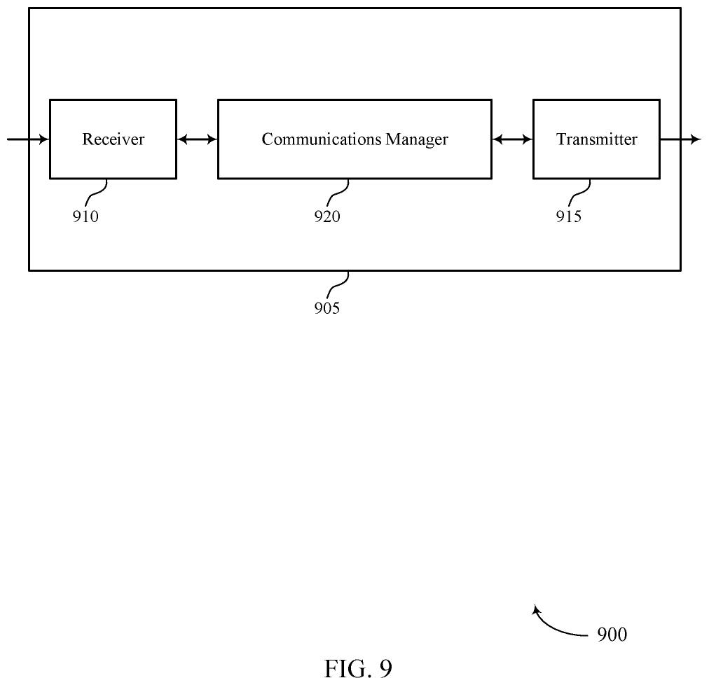

FIG. 9 shows a block diagram 900 of a device 905 that supports capability-based bandwidth restrictions for wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of capability-based bandwidth restrictions for wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for obtaining capability information for a UE, where the capability information is associated with a size of a buffer at the UE that is associated with one or more retransmission processes at the UE. The communications manager 920 is capable of, configured to, or operable to support a means for selecting a configuration for the UE associated with decoding operations for one or more downlink messages to the UE, the configuration based on the capability information for the UE. The communications manager 920 is capable of, configured to, or operable to support a means for outputting a downlink message to the UE, the downlink message including one or more encoded bits associated with a decoding operation. The communications manager 920 is capable of, configured to, or operable to support a means for obtaining feedback based on the decoding operation for the downlink message, the feedback in accordance with the one or more retransmission processes.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and more efficient utilization of communication resources.

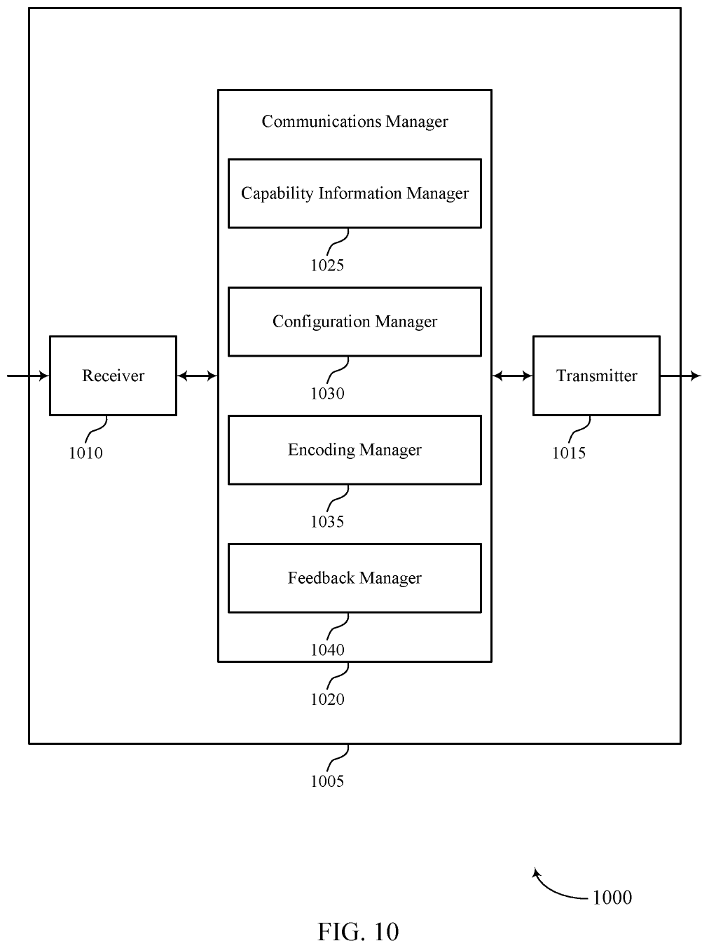

FIG. 10 shows a block diagram 1000 of a device 1005 that supports capability-based bandwidth restrictions for wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of capability-based bandwidth restrictions for wireless communications as described herein. For example, the communications manager 1020 may include a capability information manager 1025, a configuration manager 1030, an encoding manager 1035, a feedback manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The capability information manager 1025 is capable of, configured to, or operable to support a means for obtaining capability information for a UE, where the capability information is associated with a size of a buffer at the UE that is associated with one or more retransmission processes at the UE. The configuration manager 1030 is capable of, configured to, or operable to support a means for selecting a configuration for the UE associated with decoding operations for one or more downlink messages to the UE, the configuration based on the capability information for the UE. The encoding manager 1035 is capable of, configured to, or operable to support a means for outputting a downlink message to the UE, the downlink message including one or more encoded bits associated with a decoding operation. The feedback manager 1040 is capable of, configured to, or operable to support a means for obtaining feedback based on the decoding operation for the downlink message, the feedback in accordance with the one or more retransmission processes.

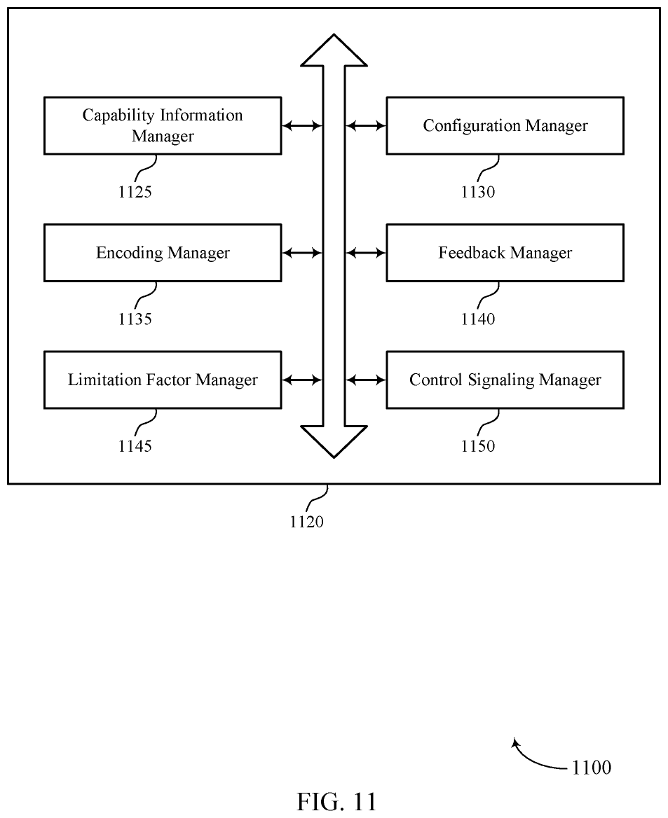

FIG. 11 shows a block diagram 1100 of a communications manager 1120 that supports capability-based bandwidth restrictions for wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of capability-based bandwidth restrictions for wireless communications as described herein. For example, the communications manager 1120 may include a capability information manager 1125, a configuration manager 1130, an encoding manager 1135, a feedback manager 1140, a limitation factor manager 1145, a control signaling manager 1150, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The capability information manager 1125 is capable of, configured to, or operable to support a means for obtaining capability information for a UE, where the capability information is associated with a size of a buffer at the UE that is associated with one or more retransmission processes at the UE. Th In some examples, the size of the buffer at the UE is based on a limitation factor associated with the capability information for the UE. In some examples, the limitation factor has an allowable range with a lower bound that is based on a TBS limit and a code rate, the TBS limit based on a maximum quantity of transmission later, a maximum modulation order, a maximum quantity of RBs, or any combination thereof for an active BWP for the UE.

e configuration manager 1130 is capable of, configured to, or operable to support a means for selecting a configuration for the UE associated with decoding operations for one or more downlink messages to the UE, the configuration based on the capability information for the UE. The encoding manager 1135 is capable of, configured to, or operable to support a means for outputting a downlink message to the UE, the downlink message including one or more encoded bits associated with a decoding operation. The feedback manager 1140 is capable of, configured to, or operable to support a means for obtaining feedback based on the decoding operation for the downlink message, the feedback in accordance with the one or more retransmission processes.

In some examples, the capability information for the UE indicates a set of candidate limitation factors for the size of the buffer at the UE. In some examples, selecting the configuration includes selecting a limitation factor from among the set of candidate limitation factors. In some examples, the control signaling manager 1150 is capable of, configured to, or operable to support a means for transmitting, to the UE, an indication of the selected limitation factor.

In some examples, the control signaling manager 1150 is capable of, configured to, or operable to support a means for transmitting, to the UE, control signaling that indicates the selected configuration, the selected configuration including whether the size of the buffer at the UE is subject to a limitation factor, one or more parameters that are associated with the limitation factor for the size of the buffer at the UE and are associated with one or more BWPs via which the UE is configured to communicate, or any combination thereof.

In some examples, for an initial transmission in a first BWP included in the one or more BWPs, a retransmission in accordance with the one or more retransmission processes at the UE is restricted to the first BWP.

In some examples, for an initial transmission in a first BWP included in the one or more BWPs, a retransmission in accordance with the one or more retransmission processes at the UE is restricted to the first BWP based on the size of the buffer at the UE being subject to the limitation factor before or after a switch of the UE to the first BWP.

In some examples, the size of the buffer at the UE is based on a maximum value from among a set of values that includes a first quantity and a second quantity, the first quantity including a limitation factor associated with the capability information for the UE, the second quantity based on a TBS limit and a code rate, and the TBS limit based on a maximum quantity of transmission layers, a maximum modulation order, a maximum quantity of RBs, or any combination thereof for an active BWP for the UE.

In some examples, the size of the buffer at the UE is based on a maximum value from among a set of values that includes a first quantity and a second quantity, the first quantity based on a limitation factor associated with the capability information for the UE, the second quantity based on a quantity of information bits in a CB.

In some examples, the configuration includes a limit for a total quantity of coded bits that the UE is to decode within a time period across a set of multiple component carriers.

In some examples, the set of multiple component carriers includes component carriers of a cell group, component carriers within a frequency range, or all component carriers configured for transmissions to the UE.

In some examples, the configuration includes a limit associated with one or more TBs that the UE is to decode within a time period, and where satisfaction of the limit is based on a quantity of undecoded CBs for the time period.

In some examples, satisfaction of the limit is independent of one or more prior transmissions of a CB or a TB included in the one or more TBs.

In some examples, the configuration includes a limit associated with one or more TBs that the UE is to decode within a time period, where an initial transmission of a CB or a TB included in the one or more TBs does not count against the limit, and where satisfaction of the limit is independent of one or more current retransmissions for the one or more TBs.

In some examples, the configuration includes a limit associated with one or more TBs that the UE is to decode within a time period, and where satisfaction of the limit is based on a sum of a first quantity and a second quantity, the first quantity based on a quantity of undecoded CBs for the time period, and the second quantity independent of an initial transmission or a current retransmission of a CB or a TB included in the one or more TBs.

In some examples, satisfaction of the limit is based on a sum of the first quantity, the second quantity, and a third quantity, and where the third quantity is based on a quantity of decoded CBs for the time period.

In some examples, satisfaction of the limit is based on a sum of the first quantity, the second quantity, a third quantity, and a fourth quantity, and where the fourth quantity is based on a quantity of bits for one or more uplink TBs scheduled for the time period.

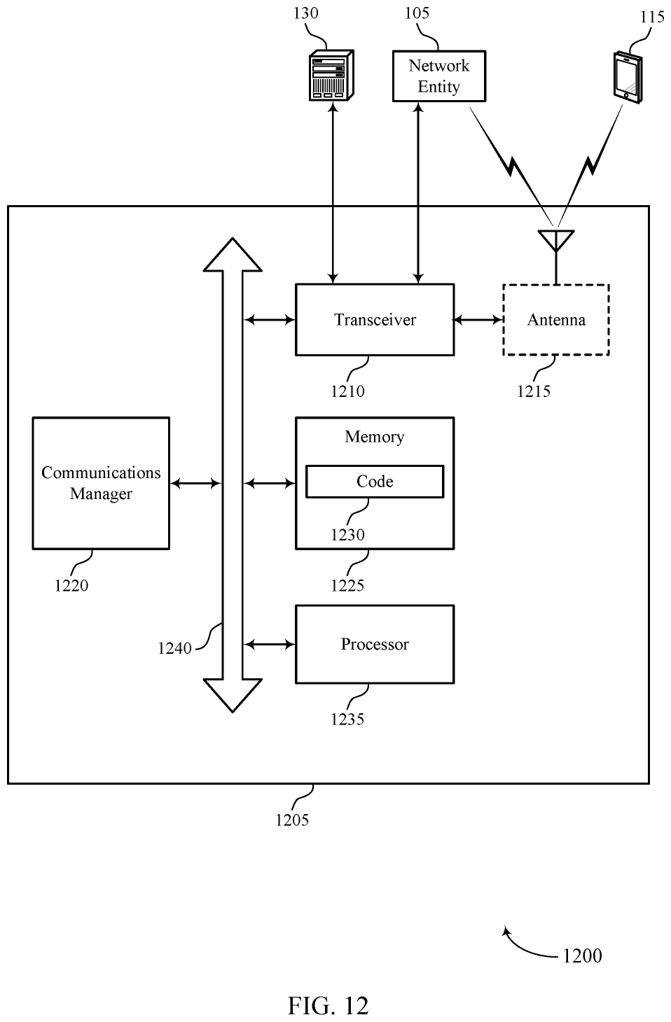

FIG. 12 shows a diagram of a system 1200 including a device 1205 that supports capability-based bandwidth restrictions for wireless communications in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting capability-based bandwidth restrictions for wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for obtaining capability information for a UE, where the capability information is associated with a size of a buffer at the UE that is associated with one or more retransmission processes at the UE. The communications manager 1220 is capable of, configured to, or operable to support a means for selecting a configuration for the UE associated with decoding operations for one or more downlink messages to the UE, the configuration based on the capability information for the UE. The communications manager 1220 is capable of, configured to, or operable to support a means for outputting a downlink message to the UE, the downlink message including one or more encoded bits associated with a decoding operation. The communications manager 1220 is capable of, configured to, or operable to support a means for obtaining feedback based on the decoding operation for the downlink message, the feedback in accordance with the one or more retransmission processes.

By including or configuring the communications manager 1220 in accordance with examples as described herein, the device 1205 may support techniques for reduced latency and improved user experience related to reduced power consumption and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of capability-based bandwidth restrictions for wireless communications as described herein, or the at least one processor 1235 and the at least one memory 1225 may be otherwise configured to, individually or collectively, perform or support such operations.

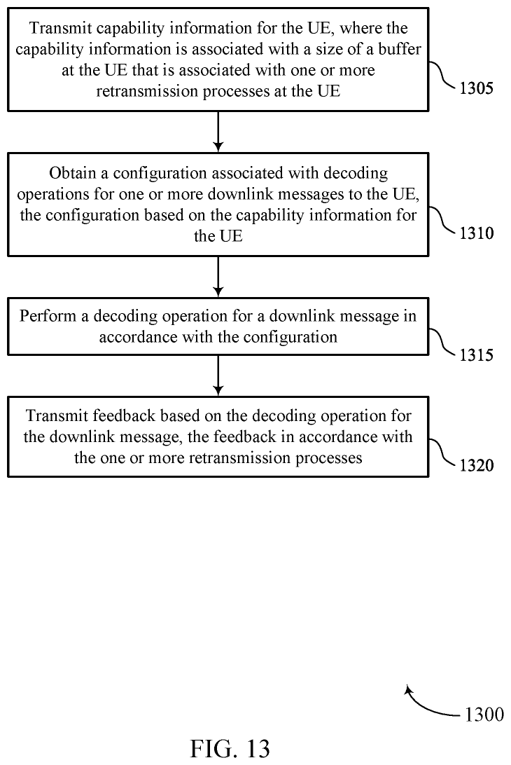

FIG. 13 shows a flowchart illustrating a method 1300 that supports capability-based bandwidth restrictions for wireless communications in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting capability information for the UE, where the capability information is associated with a size of a buffer at the UE that is associated with one or more retransmission processes at the UE. The operations of block 1305 may be performed in accordance with examples as disclosed herein. In some examples, aspects of the operations of 1305 may be performed by a capability information component 725 as described with reference to FIG. 7.

At 1310, the method may include obtaining a configuration associated with decoding operations for one or more downlink messages to the UE, the configuration based on the capability information for the UE. The operations of block 1310 may be performed in accordance with examples as disclosed herein. In some examples, aspects of the operations of 1310 may be performed by a configuration component 730 as described with reference to FIG. 7.

At 1315, the method may include performing a decoding operation for a downlink message in accordance with the configuration. The operations of block 1315 may be performed in accordance with examples as disclosed herein. In some examples, aspects of the operations of 1315 may be performed by a decoding component 735 as described with reference to FIG. 7.

At 1320, the method may include transmitting feedback based on the decoding operation for the downlink message, the feedback in accordance with the one or more retransmission processes. The operations of block 1320 may be performed in accordance with examples as disclosed herein. In some examples, aspects of the operations of 1320 may be performed by a feedback component 740 as described with reference to FIG. 7.

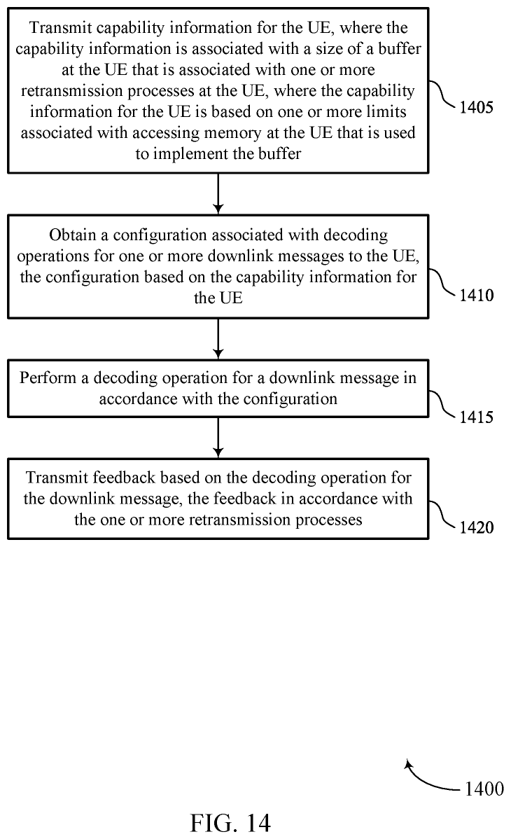

FIG. 14 shows a flowchart illustrating a method 1400 that supports capability-based bandwidth restrictions for wireless communications in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting capability information for the UE, where the capability information is associated with a size of a buffer at the UE that is associated with one or more retransmission processes at the UE, where the capability information for the UE is based on one or more limits associated with accessing memory at the UE that is used to implement the buffer. The operations of block 1405 may be performed in accordance with examples as disclosed herein. In some examples, aspects of the operations of 1405 may be performed by a capability information component 725 as described with reference to FIG. 7.

At 1410, the method may include obtaining a configuration associated with decoding operations for one or more downlink messages to the UE, the configuration based on the capability information for the UE. The operations of block 1410 may be performed in accordance with examples as disclosed herein. In some examples, aspects of the operations of 1410 may be performed by a configuration component 730 as described with reference to FIG. 7.

At 1415, the method may include performing a decoding operation for a downlink message in accordance with the configuration. The operations of block 1415 may be performed in accordance with examples as disclosed herein. In some examples, aspects of the operations of 1415 may be performed by a decoding component 735 as described with reference to FIG. 7.

At 1420, the method may include transmitting feedback based on the decoding operation for the downlink message, the feedback in accordance with the one or more retransmission processes. The operations of block 1420 may be performed in accordance with examples as disclosed herein. In some examples, aspects of the operations of 1420 may be performed by a feedback component 740 as described with reference to FIG. 7.

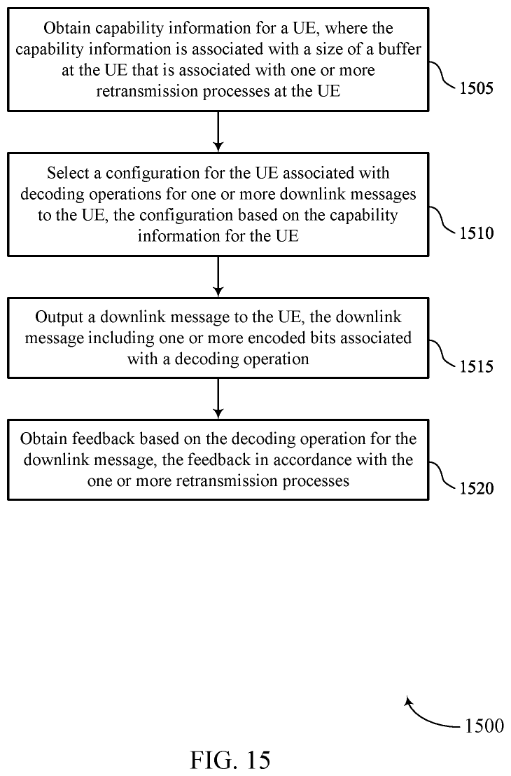

FIG. 15 shows a flowchart illustrating a method 1500 that supports capability-based bandwidth restrictions for wireless communications in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include obtaining capability information for a UE, where the capability information is associated with a size of a buffer at the UE that is associated with one or more retransmission processes at the UE. The operations of block 1505 may be performed in accordance with examples as disclosed herein. In some examples, aspects of the operations of 1505 may be performed by a capability information manager 1125 as described with reference to FIG. 11.

At 1510, the method may include selecting a configuration for the UE associated with decoding operations for one or more downlink messages to the UE, the configuration based on the capability information for the UE. The operations of block 1510 may be performed in accordance with examples as disclosed herein. In some examples, aspects of the operations of 1510 may be performed by a configuration manager 1130 as described with reference to FIG. 11.

At 1515, the method may include outputting a downlink message to the UE, the downlink message including one or more encoded bits associated with a decoding operation. The operations of block 1515 may be performed in accordance with examples as disclosed herein. In some examples, aspects of the operations of 1515 may be performed by an encoding manager 1135 as described with reference to FIG. 11.

At 1520, the method may include obtaining feedback based on the decoding operation for the downlink message, the feedback in accordance with the one or more retransmission processes. The operations of block 1520 may be performed in accordance with examples as disclosed herein. In some examples, aspects of the operations of 1520 may be performed by a feedback manager 1140 as described with reference to FIG. 11.

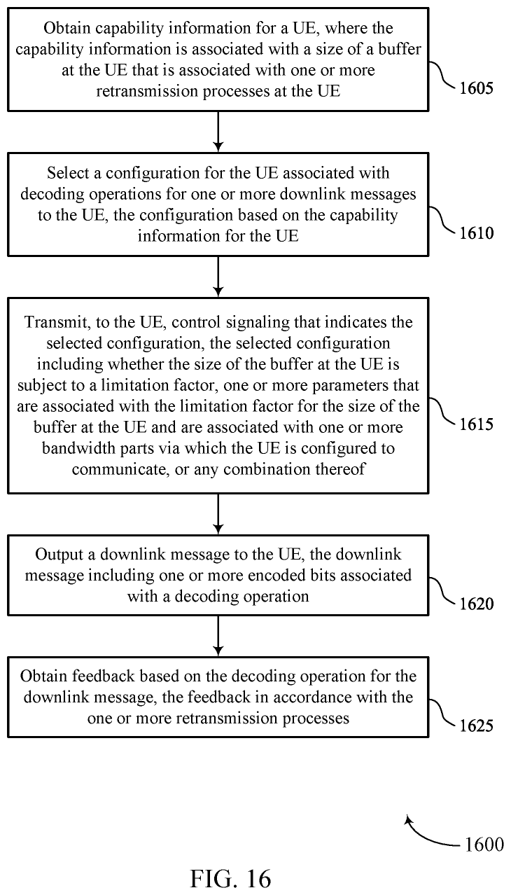

FIG. 16 shows a flowchart illustrating a method 1600 that supports capability-based bandwidth restrictions for wireless communications in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include obtaining capability information for a UE, where the capability information is associated with a size of a buffer at the UE that is associated with one or more retransmission processes at the UE. The operations of block 1605 may be performed in accordance with examples as disclosed herein. In some examples, aspects of the operations of 1605 may be performed by a capability information manager 1125 as described with reference to FIG. 11.

At 1610, the method may include selecting a configuration for the UE associated with decoding operations for one or more downlink messages to the UE, the configuration based on the capability information for the UE. The operations of block 1610 may be performed in accordance with examples as disclosed herein. In some examples, aspects of the operations of 1610 may be performed by a configuration manager 1130 as described with reference to FIG. 11.

At 1615, the method may include transmitting, to the UE, control signaling that indicates the selected configuration, the selected configuration including whether the size of the buffer at the UE is subject to a limitation factor, one or more parameters that are associated with the limitation factor for the size of the buffer at the UE and are associated with one or more BWPs via which the UE is configured to communicate, or any combination thereof. The operations of block 1615 may be performed in accordance with examples as disclosed herein. In some examples, aspects of the operations of 1615 may be performed by a control signaling manager 1150 as described with reference to FIG. 11.

At 1620, the method may include outputting a downlink message to the UE, the downlink message including one or more encoded bits associated with a decoding operation. The operations of block 1620 may be performed in accordance with examples as disclosed herein. In some examples, aspects of the operations of 1620 may be performed by an encoding manager 1135 as described with reference to FIG. 11.

At 1625, the method may include obtaining feedback based on the decoding operation for the downlink message, the feedback in accordance with the one or more retransmission processes. The operations of block 1625 may be performed in accordance with examples as disclosed herein. In some examples, aspects of the operations of 1625 may be performed by a feedback manager 1140 as described with reference to FIG. 11.

The following provides an overview of aspects of the present disclosure:

Aspect 1: A method for wireless communications at a UE, comprising: transmitting capability information for the UE, wherein the capability information is associated with a size of a buffer at the UE that is associated with one or more retransmission processes at the UE; obtaining a configuration associated with decoding operations for one or more downlink messages to the UE, the configuration based at least in part on the capability information for the UE; performing a decoding operation for a downlink message in accordance with the configuration; and transmitting feedback based at least in part on the decoding operation for the downlink message, the feedback in accordance with the one or more retransmission processes.

Aspect 2: The method of aspect 1, wherein the capability information for the UE indicates a set of candidate limitation factors for the size of the buffer at the UE; and obtaining the configuration comprises receiving, from a network entity, an indication of a selected limitation factor from among the set of candidate limitation factors.

Aspect 3: The method of aspect 1, wherein obtaining the configuration comprises: receiving, from a network entity, control signaling that indicates whether the size of the buffer at the UE is subject to a limitation factor, one or more parameters that are associated with the limitation factor for the size of the buffer at the UE and are associated with one or more bandwidth parts via which the UE is configured to communicate, or any combination thereof.

Aspect 4: The method of aspect 3, wherein, for an initial transmission in a first bandwidth part included in the one or more bandwidth parts, a retransmission in accordance with the one or more retransmission processes at the UE is restricted to the first bandwidth part.

Aspect 5: The method of any of aspects 3 through 4, wherein, for an initial transmission in a first bandwidth part included in the one or more bandwidth parts and associated with the size of the buffer, a retransmission in accordance with the one or more retransmission processes at the UE is restricted, based at least in part on the size of the buffer at the UE being subject to the limitation factor, from being in any bandwidth part associated with a buffer size that is different than the size of the buffer.

Aspect 6: The method of any of aspects 1 through 5, wherein the size of the buffer at the UE is based at least in part on a limitation factor associated with the capability information for the UE; and the limitation factor has an allowable range with a lower bound that is based at least in part on a TBS limit and a code rate, the TBS limit based at least in part on a maximum quantity of transmission layers, a maximum modulation order, a maximum quantity of RBs, or any combination thereof for an active bandwidth part for the UE.

Aspect 7: The method of any of aspects 1 through 6, wherein the size of the buffer at the UE is based at least in part on a maximum value from among a set of values that comprises a first quantity and a second quantity, the first quantity comprising a limitation factor associated with the capability information for the UE, the second quantity based at least in part on a TBS limit and a code rate, and the TBS limit based at least in part on a maximum quantity of transmission layers, a maximum modulation order, a maximum quantity of RBs, or any combination thereof for an active bandwidth part for the UE.

Aspect 8: The method of any of aspects 1 through 7, wherein the size of the buffer at the UE is based at least in part on a maximum value from among a set of values that comprises a first quantity and a second quantity, the first quantity based at least in part on a limitation factor associated with the capability information for the UE, the second quantity based at least in part on a quantity of information bits in a CB.

Aspect 9: The method of any of aspects 1 through 8, wherein the configuration comprises a limit for a total quantity of coded bits that the UE is to decode within a time period across a plurality of component carriers.

Aspect 10: The method of aspect 9, wherein the plurality of component carriers comprises component carriers of a cell group, component carriers within a frequency range, or all component carriers configured for transmissions to the UE.

Aspect 11: The method of any of aspects 9 through 10, further comprising: dropping a TB, a CB, a CB group, or any combination thereof based at least in part on a quantity of coded bits scheduled for the UE within the time period exceeding the limit.

Aspect 12: The method of any of aspects 1 through 11, wherein the configuration comprises a limit associated with one or more TBs that the UE is to decode within a time period, and wherein satisfaction of the limit is based at least in part on a quantity of undecoded CBs for the time period.

Aspect 13: The method of aspect 12, wherein satisfaction of the limit is independent of one or more prior transmissions of a CB or a TB included in the one or more TBs.

Aspect 14: The method of any of aspects 1 through 13, wherein the configuration comprises a limit associated with one or more TBs that the UE is to decode within a time period, wherein an initial transmission of a CB or a TB included in the one or more TBs does not count against the limit, and wherein satisfaction of the limit is independent of one or more current retransmissions for the one or more TBs.

Aspect 15: The method of any of aspects 1 through 14, wherein the configuration comprises a limit associated with one or more TBs that the UE is to decode within a time period, and wherein satisfaction of the limit is based at least in part on a sum of a first quantity and a second quantity, the first quantity based at least in part on a quantity of undecoded CBs for the time period, and the second quantity independent of an initial transmission or a current retransmission of a CB or a TB included in the one or more TBs.

Aspect 16: The method of aspect 15, wherein satisfaction of the limit is based at least in part on a sum of the first quantity, the second quantity, and a third quantity, and wherein the third quantity is based at least in part on a quantity of decoded CBs for the time period.

Aspect 17: The method of any of aspects 15 through 16, wherein satisfaction of the limit is based at least in part on a sum of the first quantity, the second quantity, a third quantity, and a fourth quantity, and wherein the fourth quantity is based at least in part on a quantity of bits for one or more uplink TBs scheduled for the time period.

Aspect 18: The method of any of aspects 1 through 17, further comprising: implementing the buffer using memory at the UE, wherein the capability information for the UE is based at least in part on one or more limits associated with accessing the memory at the UE.

Aspect 19: The method of any of aspects 1 through 18, wherein the buffer is a circular buffer for a CB.

Aspect 20: A method for wireless communications at a network entity, comprising: obtaining capability information for a UE, wherein the capability information is associated with a size of a buffer at the UE that is associated with one or more retransmission processes at the UE; selecting a configuration for the UE associated with decoding operations for one or more downlink messages to the UE, the configuration based at least in part on the capability information for the UE; outputting a downlink message to the UE, the downlink message including one or more encoded bits associated with a decoding operation; and obtaining feedback based at least in part on the decoding operation for the downlink message, the feedback in accordance with the one or more retransmission processes.

Aspect 21: The method of aspect 20, wherein the capability information for the UE indicates a set of candidate limitation factors for the size of the buffer at the UE; selecting the configuration comprises selecting a limitation factor from among the set of candidate limitation factors; and the method further comprises transmitting, to the UE, an indication of the selected limitation factor.

Aspect 22: The method of aspect 20, further comprising: transmitting, to the UE, control signaling that indicates the selected configuration, the selected configuration comprising whether the size of the buffer at the UE is subject to a limitation factor, one or more parameters that are associated with the limitation factor for the size of the buffer at the UE and are associated with one or more bandwidth parts via which the UE is configured to communicate, or any combination thereof.

Aspect 23: The method of aspect 22, wherein, for an initial transmission in a first bandwidth part included in the one or more bandwidth parts, a retransmission in accordance with the one or more retransmission processes at the UE is restricted to the first bandwidth part.

Aspect 24: The method of any of aspects 22 through 23, wherein, for an initial transmission in a first bandwidth part included in the one or more bandwidth parts, a retransmission in accordance with the one or more retransmission processes at the UE is restricted to the first bandwidth part based at least in part on the size of the buffer at the UE being subject to the limitation factor before or after a switch of the UE to the first bandwidth part.

Aspect 25: The method of any of aspects 22 through 24, wherein the size of the buffer at the UE is based at least in part on a maximum value from among a set of values that comprises a first quantity and a second quantity, the first quantity based at least in part on a limitation factor associated with the capability information for the UE, the second quantity based at least in part on a quantity of information bits in a CB.

Aspect 26: The method of any of aspects 20 through 25, wherein the size of the buffer at the UE is based at least in part on a limitation factor associated with the capability information for the UE; and the limitation factor has an allowable range with a lower bound that is based at least in part on a TBS limit and a code rate, the TBS limit based at least in part on a maximum quantity of transmission later, a maximum modulation order, a maximum quantity of RBs, or any combination thereof for an active bandwidth part for the UE.

Aspect 27: The method of any of aspects 20 through 26, wherein the size of the buffer at the UE is based at least in part on a maximum value from among a set of values that comprises a first quantity and a second quantity, the first quantity comprising a limitation factor associated with the capability information for the UE, the second quantity based at least in part on a TBS limit and a code rate, and the TBS limit based at least in part on a maximum quantity of transmission layers, a maximum modulation order, a maximum quantity of RBs, or any combination thereof for an active bandwidth part for the UE.

Aspect 28: The method of any of aspects 20 through 27, wherein the configuration comprises a limit for a total quantity of coded bits that the UE is to decode within a time period across a plurality of component carriers.

Aspect 29: The method of aspect 28, wherein the plurality of component carriers comprises component carriers of a cell group, component carriers within a frequency range, or all component carriers configured for transmissions to the UE.

Aspect 30: The method of any of aspects 20 through 29, wherein the configuration comprises a limit associated with one or more TBs that the UE is to decode within a time period, and wherein satisfaction of the limit is based at least in part on a quantity of undecoded CBs for the time period.

Aspect 31: The method of aspect 30, wherein satisfaction of the limit is independent of one or more prior transmissions of a CB or a TB included in the one or more TBs.

Aspect 32: The method of any of aspects 20 through 31, wherein the configuration comprises a limit associated with one or more TBs that the UE is to decode within a time period, wherein an initial transmission of a CB or a TB included in the one or more TBs does not count against the limit, and wherein satisfaction of the limit is independent of one or more current retransmissions for the one or more TBs.

Aspect 33: The method of any of aspects 20 through 32, wherein the configuration comprises a limit associated with one or more TBs that the UE is to decode within a time period, and wherein satisfaction of the limit is based at least in part on a sum of a first quantity and a second quantity, the first quantity based at least in part on a quantity of undecoded CBs for the time period, and the second quantity independent of an initial transmission or a current retransmission of a CB or a TB included in the one or more TBs.

Aspect 34: The method of aspect 33, wherein satisfaction of the limit is based at least in part on a sum of the first quantity, the second quantity, and a third quantity, and wherein the third quantity is based at least in part on a quantity of decoded CBs for the time period.

Aspect 35: The method of any of aspects 33 through 34, wherein satisfaction of the limit is based at least in part on a sum of the first quantity, the second quantity, a third quantity, and a fourth quantity, and wherein the fourth quantity is based at least in part on a quantity of bits for one or more uplink TBs scheduled for the time period.

Aspect 36: A UE for wireless communications, comprising one or more memories storing processor-executable code, and one or more processors coupled with the one or more memories and individually or collectively operable to execute the code to cause the UE to perform a method of any of aspects 1 through 19.

Aspect 37: A UE for wireless communications, comprising at least one means for performing a method of any of aspects 1 through 19.

Aspect 38: A non-transitory computer-readable medium storing code for wireless communications, the code comprising instructions executable by a processor to perform a method of any of aspects 1 through 19.

Aspect 39: A network entity for wireless communications, comprising one or more memories storing processor-executable code, and one or more processors coupled with the one or more memories and individually or collectively operable to execute the code to cause the network entity to perform a method of any of aspects 20 through 35.

Aspect 40: A network entity for wireless communications, comprising at least one means for performing a method of any of aspects 20 through 35.

Aspect 41: A non-transitory computer-readable medium storing code for wireless communications, the code comprising instructions executable by a processor to perform a method of any of aspects 20 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD)ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit capability information for the UE, wherein the capability information is associated with a size of a buffer at the UE that is associated with one or more retransmission processes at the UE;
obtain a configuration associated with decoding operations for one or more downlink messages to the UE, the configuration based at least in part on the capability information for the UE;
perform a decoding operation for a downlink message in accordance with the configuration; and
transmit feedback based at least in part on the decoding operation for the downlink message, the feedback in accordance with the one or more retransmission processes.

2. The UE of claim 1, wherein:
the capability information for the UE indicates a set of candidate limitation factors for the size of the buffer at the UE; and
to obtain the configuration, the one or more processors are individually or collectively operable to execute the code to cause the UE to receive, from a network entity, an indication of a selected limitation factor from among the set of candidate limitation factors.

3. The UE of claim 1, wherein, to obtain the configuration, the one or more processors are individually or collectively operable to execute the code to cause the UE to:
receive, from a network entity, control signaling that indicates whether the size of the buffer at the UE is subject to a limitation factor, or one or more parameters that are associated with the limitation factor for the size of the buffer at the UE and are associated with one or more bandwidth parts via which the UE is configured to communicate, or any combination thereof.

4. The UE of claim 3, wherein for an initial transmission in a first bandwidth part included in the one or more bandwidth parts, a retransmission in accordance with the one or more retransmission processes at the UE is restricted to the first bandwidth part.

5. The UE of claim 3, wherein for an initial transmission in a first bandwidth part included in the one or more bandwidth parts and associated with the size of the buffer, a retransmission in accordance with the one or more retransmission processes at the UE is restricted, based at least in part on the size of the buffer at the UE being subject to the limitation factor, from being in any bandwidth part associated with a buffer size that is different than the size of the buffer.

6. The UE of claim 1, wherein:
the size of the buffer at the UE is based at least in part on a limitation factor associated with the capability information for the UE; and
the limitation factor has an allowable range with a lower bound that is based at least in part on a transport block size limit and a code rate, the transport block size limit based at least in part on a maximum quantity of transmission layers, a maximum modulation order, a maximum quantity of resource blocks, or any combination thereof for an active bandwidth part for the UE.

7. The UE of claim 1, wherein the size of the buffer at the UE is based at least in part on a maximum value from among a set of values that comprises a first quantity and a second quantity, the first quantity comprising a limitation factor associated with the capability information for the UE, the second quantity based at least in part on a transport block size limit and a code rate, and the transport block size limit based at least in part on a maximum quantity of transmission layers, a maximum modulation order, a maximum quantity of resource blocks, or any combination thereof for an active bandwidth part for the UE.

8. The UE of claim 1, wherein the size of the buffer at the UE is based at least in part on a maximum value from among a set of values that comprises a first quantity and a second quantity, the first quantity based at least in part on a limitation factor associated with the capability information for the UE, the second quantity based at least in part on a quantity of information bits in a code block.

9. The UE of claim 1, wherein the configuration comprises a limit for a total quantity of coded bits that the UE is to decode within a time period across a plurality of component carriers.

10. The UE of claim 9, wherein the plurality of component carriers comprises component carriers of a cell group, component carriers within a frequency range, or all component carriers configured for transmissions to the UE.

11. The UE of claim 9, wherein the one or more processors are individually or collectively further operable to execute the code to cause the UE to:
drop a transport block, a code block, a code block group, or any combination thereof based at least in part on a quantity of coded bits scheduled for the UE within the time period exceeding the limit.

12. The UE of claim 1, wherein the configuration comprises a limit associated with one or more transport blocks that the UE is to decode within a time period, and wherein satisfaction of the limit is based at least in part on a quantity of undecoded code blocks for the time period.

13. The UE of claim 12, wherein satisfaction of the limit is independent of one or more prior transmissions of a code block or a transport block included in the one or more transport blocks.

14. The UE of claim 1, wherein the configuration comprises a limit associated with one or more transport blocks that the UE is to decode within a time period, wherein an initial transmission of a code block or a transport block included in the one or more transport blocks does not count against the limit, and wherein satisfaction of the limit is independent of one or more current retransmissions for the one or more transport blocks.

15. The UE of claim 1, wherein the configuration comprises a limit associated with one or more transport blocks that the UE is to decode within a time period, and wherein satisfaction of the limit is based at least in part on a sum of a first quantity and a second quantity, the first quantity based at least in part on a quantity of undecoded code blocks for the time period, and the second quantity independent of an initial transmission or a current retransmission of a code block or a transport block included in the one or more transport blocks.

16. The UE of claim 15, wherein satisfaction of the limit is based at least in part on a sum of the first quantity, the second quantity, and a third quantity, and wherein the third quantity is based at least in part on a quantity of decoded code blocks for the time period.

17. The UE of claim 15, wherein satisfaction of the limit is based at least in part on a sum of the first quantity, the second quantity, a third quantity, and a fourth quantity, and wherein the fourth quantity is based at least in part on a quantity of bits for one or more uplink transport blocks scheduled for the time period.

18. The UE of claim 1, wherein the one or more processors are individually or collectively further operable to execute the code to cause the UE to:
implement the buffer using memory at the UE, the memory separate from or included in the one or more memories storing the processor-executable code, wherein the capability information for the UE is based at least in part on one or more limits associated with accessing the memory at the UE.

19. A network entity, comprising:
one or more memories storing processor-executable code; and
one or more processors coupled with the one or more memories and individually or collectively operable to execute the code to cause the network entity to:
obtain capability information for a user equipment (UE), wherein the capability information is associated with a size of a buffer at the UE that is associated with one or more retransmission processes at the UE;
select a configuration for the UE associated with decoding operations for one or more downlink messages to the UE, the configuration based at least in part on the capability information for the UE;
output a downlink message to the UE, the downlink message including one or more encoded bits associated with a decoding operation; and
obtain feedback based at least in part on the decoding operation for the downlink message, the feedback in accordance with the one or more retransmission processes.

20. The network entity of claim 19, wherein:
the capability information for the UE indicates a set of candidate limitation factors for the size of the buffer at the UE;
to select the configuration, the one or more processors are individually or collectively further operable to cause the network entity to select a limitation factor from among the set of candidate limitation factors; and
the one or more processors are individually or collectively further operable to cause the network entity to transmit, to the UE, an indication of the selected limitation factor.

21. The network entity of claim 19, wherein the one or more processors are individually or collectively further operable to execute the code to cause the network entity to:
transmit, to the UE, control signaling that indicates the selected configuration, the selected configuration comprising whether the size of the buffer at the UE is subject to a limitation factor, one or more parameters that are associated with the limitation factor for the size of the buffer at the UE and are associated with one or more bandwidth parts via which the UE is configured to communicate, or any combination thereof.

22. The network entity of claim 19, wherein:
the size of the buffer at the UE is based at least in part on a limitation factor associated with the capability information for the UE; and
the limitation factor has an allowable range with a lower bound that is based at least in part on a transport block size limit and a code rate, the transport block size limit based at least in part on a maximum quantity of transmission later, a maximum modulation order, a maximum quantity of resource blocks, or any combination thereof for an active bandwidth part for the UE.

23. The network entity of claim 19, wherein the size of the buffer at the UE is based at least in part on a maximum value from among a set of values that comprises a first quantity and a second quantity, the first quantity comprising a limitation factor associated with the capability information for the UE, the second quantity based at least in part on a transport block size limit and a code rate, and the transport block size limit based at least in part on a maximum quantity of transmission layers, a maximum modulation order, a maximum quantity of resource blocks, or any combination thereof for an active bandwidth part for the UE.

24. The network entity of claim 19, wherein the size of the buffer at the UE is based at least in part on a maximum value from among a set of values that comprises a first quantity and a second quantity, the first quantity based at least in part on a limitation factor associated with the capability information for the UE, the second quantity based at least in part on a quantity of information bits in a code block.

25. The network entity of claim 19, wherein the configuration comprises a limit for a total quantity of coded bits that the UE is to decode within a time period across a plurality of component carriers.

26. The network entity of claim 19, wherein the configuration comprises a limit associated with one or more transport blocks that the UE is to decode within a time period, and wherein satisfaction of the limit is based at least in part on a quantity of undecoded code blocks for the time period.

27. The network entity of claim 19, wherein the configuration comprises a limit associated with one or more transport blocks that the UE is to decode within a time period, wherein an initial transmission of a code block or a transport block included in the one or more transport blocks does not count against the limit, and wherein satisfaction of the limit is independent of one or more current retransmissions for the one or more transport blocks.

28. The network entity of claim 19, wherein the configuration comprises a limit associated with one or more transport blocks that the UE is to decode within a time period, and wherein satisfaction of the limit is based at least in part on a sum of a first quantity and a second quantity, the first quantity based at least in part on a quantity of undecoded code blocks for the time period, and the second quantity independent of an initial transmission or a current retransmission of a code block or a transport block included in the one or more transport blocks.

29. A method for wireless communications at a user equipment (UE), comprising:
transmitting capability information for the UE, wherein the capability information is associated with a size of a buffer at the UE that is associated with one or more retransmission processes at the UE;
obtaining a configuration associated with decoding operations for one or more downlink messages to the UE, the configuration based at least in part on the capability information for the UE;
performing a decoding operation for a downlink message in accordance with the configuration; and
transmitting feedback based at least in part on the decoding operation for the downlink message, the feedback in accordance with the one or more retransmission processes.

30. A method for wireless communications at a network entity, comprising:
obtaining capability information for a user equipment (UE), wherein the capability information is associated with a size of a buffer at the UE that is associated with one or more retransmission processes at the UE;
selecting a configuration for the UE associated with decoding operations for one or more downlink messages to the UE, the configuration based at least in part on the capability information for the UE;
outputting a downlink message to the UE, the downlink message including one or more encoded bits associated with a decoding operation; and
obtaining feedback based at least in part on the decoding operation for the downlink message, the feedback in accordance with the one or more retransmission processes.
